(19) United States
(12) Patent Application Publication
(10) Pub. No.: US 2016/0224273 A1
(43) Pub. Date: Aug. 4, 2016

(54) CONTROLLER AND STORAGE SYSTEM

(71) Applicant: FUJITSU LIMITED, Kawasaki-shi (JP)

(72) Inventor: Yoshinari Shinozaki, Kawasaki (JP)

(73) Assignee: FUJITSU LIMITED, Kawasaki-shi (JP)

(21) Appl. No.: 14/966,282

(22) Filed: Dec. 11, 2015

(30) Foreign Application Priority Data
Jan. 30, 2015 (JP) 2015-017390

(51) Int. Cl. G06F 3/06

(52) U.S. Cl. CPC G06F 3/0647; G06F 3/0619; G06F 3/0689; G06F 3/0688

(57) ABSTRACT

A controller included in a first storage device communicably connected to a second storage device includes a processor. The processor is configured to determine a source storage device and a destination storage device upon receiving a relocation instruction. The relocation instruction instructs to relocate first data from a source storage unit to a destination storage unit. The source storage device includes the source storage unit. The destination storage device includes the destination storage unit. The source storage unit is a relocation source of the first data. The destination storage unit is a relocation destination of the first data. The processor is configured to migrate, upon determining that the source storage device is the first storage device and that the destination storage device is the second storage device, the first data by copying the first data to the second storage device by using an inter-device copy function.

### CROSS-REFERENCE TO RELATED APPLICATION

This application is based upon and claims the benefit of priority of the prior Japanese Patent Application No. 2015-017390, filed on Jan. 30, 2015, the entire contents of which are incorporated herein by reference.

### FIELD

The embodiment discussed herein is related to a controller and a storage system.

### BACKGROUND

Data is often stored in a storage device for a long period of time. In general, reference frequency of information drops after elapse of a certain period of time from the generation of the information. In this regard, there is a problem in that a high performance storage device (disk) is occupied by data stored for a long period of time due to difficulty in managing the access state of the data.

For solving the foregoing problem, a technique called automated storage tiering (AST) is known. The automated storage tiering is a function used in an environment where storage units of different types co-exist, and configured to monitor data access to the storage by detecting the access frequency to the data, and to automatically relocate the data between the storage units in accordance with preset policies. For example, storage costs may be reduced by locating data of low use frequency into an inexpensive near-line drive with a large capacity. Also, reduction in response time and improvement in performance may be expected by locating data of high access frequency into a high performance solid state drive (SSD) or an on-line disk.

Related techniques are disclosed in, for example, Japanese Laid-open Patent Publication No. 2012-43407 and Japanese Laid-open Patent Publication No. 2009-289252.

In order to implement automated storage tiering as described above, multiple storage units are desired, because different types of storage units are prepared to form a configuration of redundant array of inexpensive disks (RAID).

However, a storage device of an entry level may have a limit on the number of storage units mountable thereon. Also, in actual operations, the number of storage units used in each tier may have leeway or run short contrary to initial expectations.

In such cases, however, a sufficient number of additional storage units are not always mounted on the storage device.

### SUMMARY

According to an aspect of the present invention, provided is a controller included in a first storage device communicably connected to a second storage device. The controller includes a processor. The processor is configured to determine a source storage device and a destination storage device upon receiving a relocation instruction. The relocation instruction instructs to relocate first data from a source storage unit to a destination storage unit. The source storage device includes the source storage unit. The destination storage device includes the destination storage unit. The source storage unit is a relocation source of the first data. The destination storage unit is a relocation destination of the first data. The processor is configured to migrate, upon determining that the source storage device is the first storage device and that the destination storage device is the second storage device, the first data by copying the first data to the second storage device by using an inter-device copy function.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a storage system according to an embodiment;

FIG. 2 is a diagram illustrating exemplary software modules and information stored in a memory provided in a CM (controller) included in a storage system according to an embodiment;

FIG. 3 is a diagram illustrating a configuration of functions implemented by a CPU (computer) provided in a CM included in a storage system according to an embodiment;

FIG. 4 is a diagram illustrating data relocation processing in a storage system according to an embodiment;

FIG. 5 is a diagram illustrating an example of a tier group table in a storage system according to an embodiment;

FIG. 6 is a diagram illustrating an example of a session table in a storage system according to an embodiment;

FIG. 7 is a flowchart illustrating tier group information generation processing in a storage system according to an embodiment;

FIG. 8 is a flowchart illustrating tier management group information generation processing in a storage system according to an embodiment;

FIG. 9 is a flowchart illustrating relocation device determination processing in a storage system according to an embodiment;

FIG. 10 is a diagram illustrating a first example of data relocation processing in a storage system according to an embodiment;

FIG. 11 is a flowchart illustrating a first example of data relocation processing in a storage system according to an embodiment;

FIG. 12 is a flowchart illustrating a first example of data relocation processing in a storage system according to an embodiment;

FIG. 13 is a diagram illustrating a second example of data relocation processing in a storage system according to an embodiment;

FIG. 14 is a flowchart illustrating a second example of data relocation processing in a storage system according to an embodiment;

FIG. 15 is a flowchart illustrating a second example of data relocation processing in a storage system according to an embodiment;

FIG. 16 is a diagram illustrating a third example of data relocation processing in a storage system according to an embodiment;

FIG. 17 is a flowchart illustrating a third example of data relocation processing in a storage system according to an embodiment;

FIG. 18 is a flowchart illustrating a third example of data relocation processing in a storage system according to an embodiment;

FIG. 19 is a flowchart illustrating a third example of data relocation processing in a storage system according to an embodiment;

FIG. 20A is a diagram illustrating states of session tables before rewriting or deletion thereof in a third example of data relocation processing in a storage system according to an embodiment;

FIG. 20B is a diagram illustrating states of session tables after rewriting or deletion thereof in a third example of data relocation processing in a storage system according to an embodiment;

FIG. 21 is a diagram illustrating a session table before rewriting thereof, which is used by a storage device of a relocation instruction source, in a third example of data relocation processing in a storage system according to an embodiment;

FIG. 22A is a diagram illustrating a session table prior to start of data relocation processing, which is used by a storage device of a relocation source, in a third example of data relocation processing in a storage system according to an embodiment;

FIG. 22B is a diagram illustrating a session table after completion of data relocation processing, which is used by a storage device of a relocation source, in a third example of data relocation processing in a storage system according to an embodiment;

FIG. 23A is a diagram illustrating data to be rewritten within a session table in a third example of data relocation processing in a storage system according to an embodiment;

FIG. 23B is a diagram illustrating data after rewriting within a session table in a third example of data relocation processing in a storage system according to an embodiment;

FIG. 24 is a diagram illustrating a session table after rewriting, which is used by a storage device of a relocation instruction source, in a third example of data relocation processing in a storage system according to an embodiment;

FIG. 25 is a flowchart illustrating write processing in a storage system according to an embodiment;

FIG. 26 is a flowchart illustrating write processing in a storage system according to an embodiment;

FIG. 27 is a flowchart illustrating read processing in a storage system according to an embodiment; and

FIG. 28 is a flowchart illustrating read processing in a storage system according to an embodiment.

### DESCRIPTION OF EMBODIMENT

Hereinafter, an embodiment of a controller and a storage system is described with reference to the accompanying drawings. However, the embodiment described below is merely illustrative, and not intended to exclude various modifications and application of techniques not specified herein. That is, the embodiment may be implemented by modifying in various ways without departing from the spirit thereof.

Respective drawings are not intended to include only components illustrated therein, but may include other features, and so on.

Hereinafter, in the drawings, an identical reference numeral represents an identical or similar element, and description thereof is omitted.

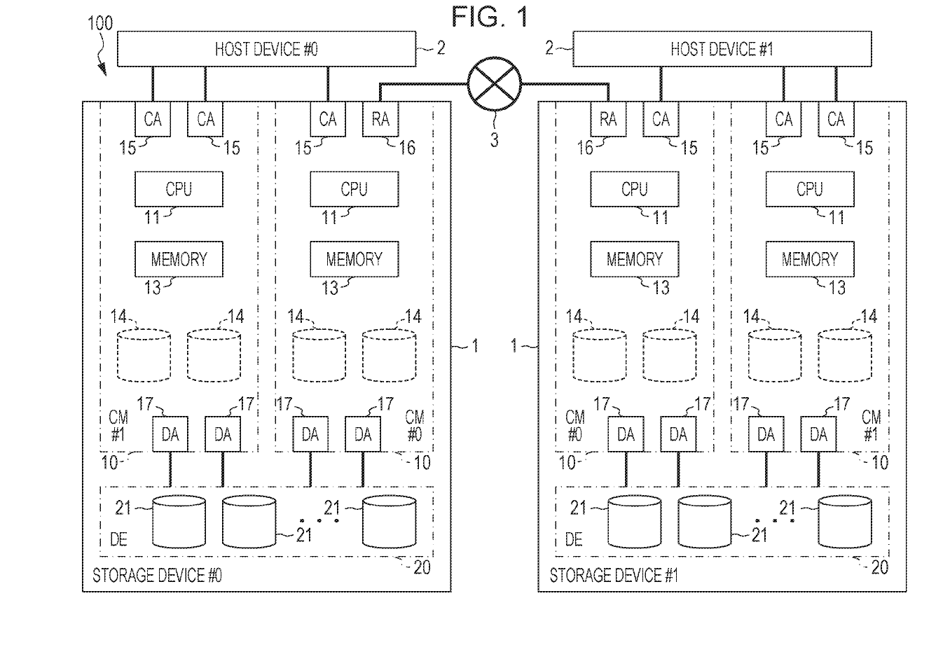

FIG. 1 is a diagram illustrating an exemplary configuration of a storage system according to the embodiment. A storage system 100 illustrated in FIG. 1 provides a physical storage area to a host device 2, and includes multiple (two in the illustrated example) storage devices 1 (storage devices #0, #1), multiple (two in the illustrated example) host devices 2 (host devices #0, #1; monitoring server), and a switch 3.

Hereinafter, when specifying one of the multiple storage devices, the storage device is referred to as the “storage device #0” or “storage device #1”. However, when indicating any one of the storage devices, the storage device is referred to as a “storage device 1”. Also, hereinafter, when specifying one of the multiple host devices, the host device is referred to as the “host device #0” or “host device #1”. However, when indicating any one of the host devices, the host device is referred to as “host device 2”.

The switch 3 is a device configured to relay a network between the storage device #0 and the storage device #1, such as, for example, a fiber channel (FC) switch.

The host device 2 is, for example, a computer including a server function, and includes a central processing unit (CPU) (not illustrated) and a memory. The CPU instructs, by executing management software stored in the memory, the storage device 1 to relocate data in the data relocation processing according to the embodiment to manage the storage device 1. The operator manages the storage system 100 via the host device 2. In the example illustrated in FIG. 1, the storage system 100 includes two host devices 2. However, the number of host devices 2 provided in the storage system 100 may be changed variously. The host device 2 may comprise a feature working as an operation server, or the storage system 100 may comprise a server working as an operation server separately from the host device 2.

The storage device 1 is a device including multiple storage units 21 described below for providing a storage area to the host device 2. For example, by using the RAID, data is dispersedly stored into the multiple storage units 21 in a redundant state. The storage device 1 has an automated storage tiering function. The storage device 1 includes multiple (two in the illustrated example) centralized modules (CM) 10 (CM #0, #1; controller), and a disk enclosure (DE) 20. In the example illustrated in FIG. 1, the storage system 100 includes two storage devices 1. However, the number of storage devices 1 provided in the storage system 100 may be changed variously.

Hereinafter, when specifying one of the multiple CMs, the CM is referred to as the “CM #0” or the “CM #1”. However, when indicating any one of the CMs, the CM is referred to as a “CM 10”.

The DE 20 is communicably connected to both of the CMs #0, #1 via access paths for redundancy, and includes multiple storage units 21.

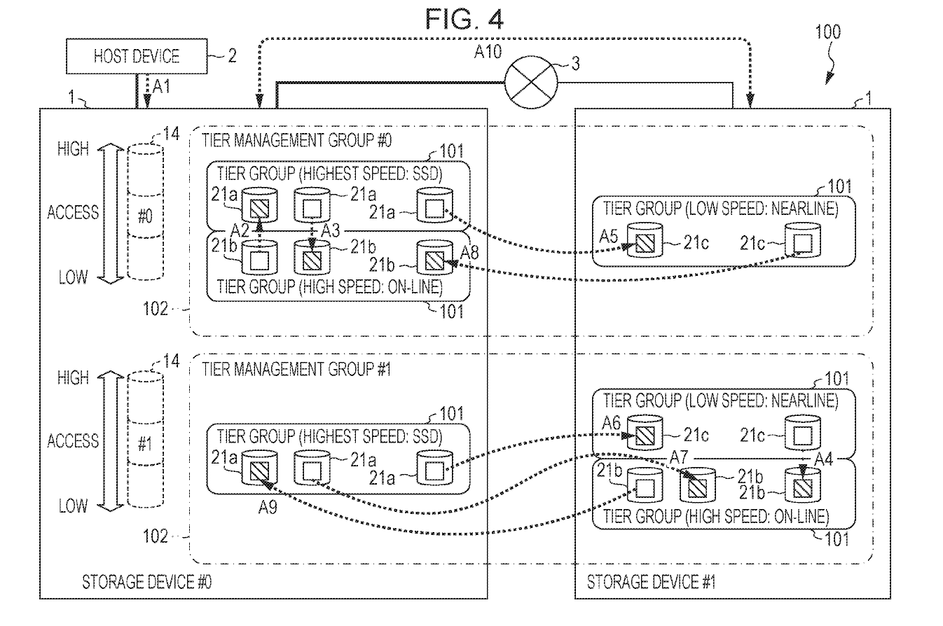

The storage units 21 are known devices for storing data in a readable and writable manner. The storage units 21 include, for example, an SSD 21a and a hard disk drive (HDD) such as an on-line disk 21b and a near-line disk 21c, which are described below with reference to FIG. 4.

CM 10 is a controller configured to perform various controls in accordance with a storage access request (access control signal: hereinafter referred to as host input/output (I/O)) from the host device 2. The CM #0 includes a CPU 11 (computer), a memory 13, a communication adapter (CA) 15, a remote adapter (RA) 16, and two device adapters (DA) 17. The CM #1 includes a CPU 11, a memory 13, two CAs 15, and two DAs 17. In the example illustrated in FIG. 1, the CM #1 includes no RA 16 unlike the CM #0. However, the CM #1 is not limited thereto, and may include the RA 16 similarly to the CM #0. Multiple (two in the illustrated example) virtual volumes 14 recognized by the host device 2 to perform host I/O are deployed in the CM 10.

The CA 15 is an interface controller configured to communicably connect the CM 10 and the host device 2 to each other. The CA 15 and the host device 2 are connected to each other, for example, via a local area network (LAN) cable.

The RA 16 is an interface controller configured to communicably connect the CM 10 to other storage devices 1 via the switch 3. The RA 16 and the switch 3 are connected to each other, for example, via a LAN cable.

The DA 17 is an interface such as, for example, an FC adapter, for communicably connecting the CM 10 and the DE 20 to each other. The CM 10 writes and reads data to and from the storage unit 21 via the DA 17.

The memory 13 is a storage unit including a read-only memory (ROM) and a random access memory (RAM). The ROM of the memory 13 contains programs such as a basic input/output system (BIOS). A software program on the memory 13 is read and implemented by the CPU 11 as appropriate. The RAM of the memory 13 is utilized as a primary recording memory, a working memory, and a buffer memory.

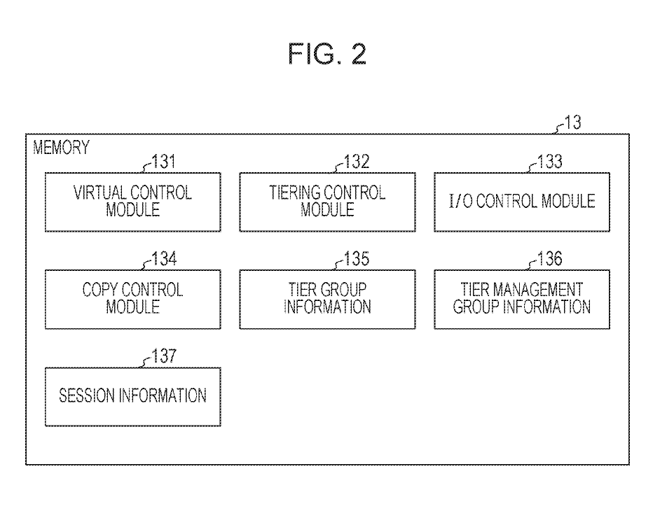

FIG. 2 is a diagram illustrating exemplary software modules and information stored in the memory 13 provided in the CM 10 included in the storage system 100 according to the embodiment.

The memory 13 stores therein a virtual control module 131, a tiering control module 132, an I/O control module 133, a copy control module 134, tier group information 135 (storage unit information), tier management group information 136 (storage unit group information), and session information 137 (copy session information). Specifically, the ROM of the memory 13 stores therein the virtual control module 131, the tiering control module 132, the I/O control module 133, and the copy control module 134. The RAM of the memory 13 stores therein the tier group information 135, the tier management group information 136, and the session information 137.

The CPU 11 executes the virtual control module 131 to deploy a storage area of the storage unit 21 as a virtual volume 14, and manage the deployed virtual volume 14 in a state recognizable to the host device 2.

The CPU 11 executes the tiering control module 132 to tier and manage the virtual volumes 14 on the basis of the data access performance of the storage unit 21, as described later with reference to FIG. 4 and so on.

The CPU 11 manages the host I/O via the CA 15 by executing the I/O control module 133.

The CPU 11 executes the copy control module 134 to perform data copy processing between storage units 21 within a single storage device 1 or across multiple storage devices 1, as described below with reference to FIG. 4 and so on.

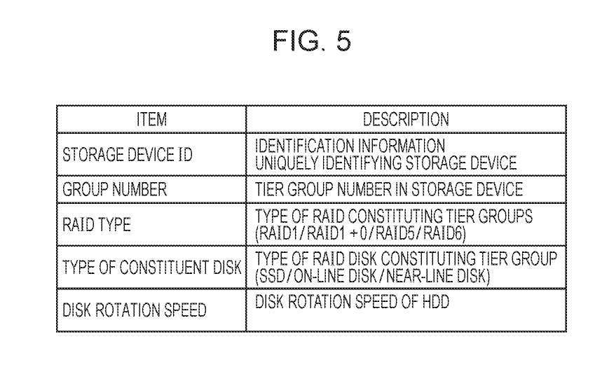

The tier group information 135 is information for grouping storage units 21 by the type of the storage unit 21, the RAID type, and so on. The tier group information 135 is described below in detail with reference to FIGS. 4 and 5.

The tier management group information 136 is information for grouping and managing multiple sets of the tier group information 135. The tier management group information 136 is described below in detail with reference to FIG. 4 and so on.

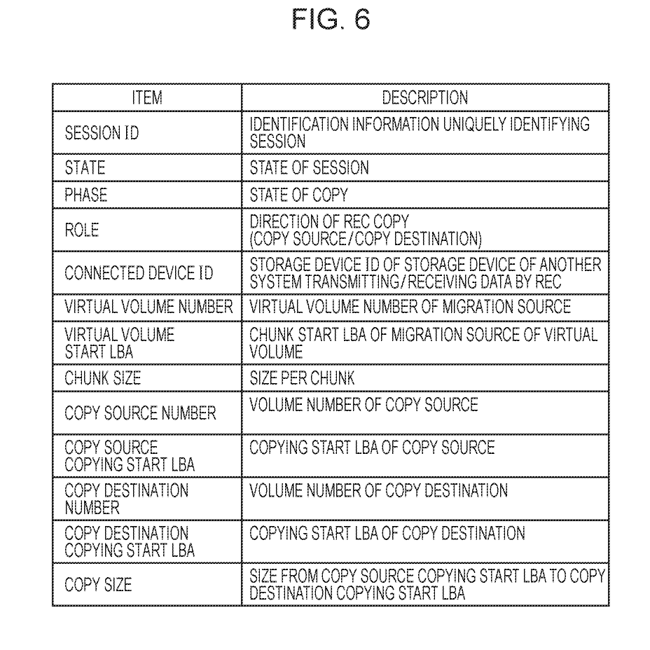

The session information 137 is information for managing the data copy processing between storage units 21 across multiple storage devices 1. The session information 137 is described below in detail with reference to FIG. 6 and so on.

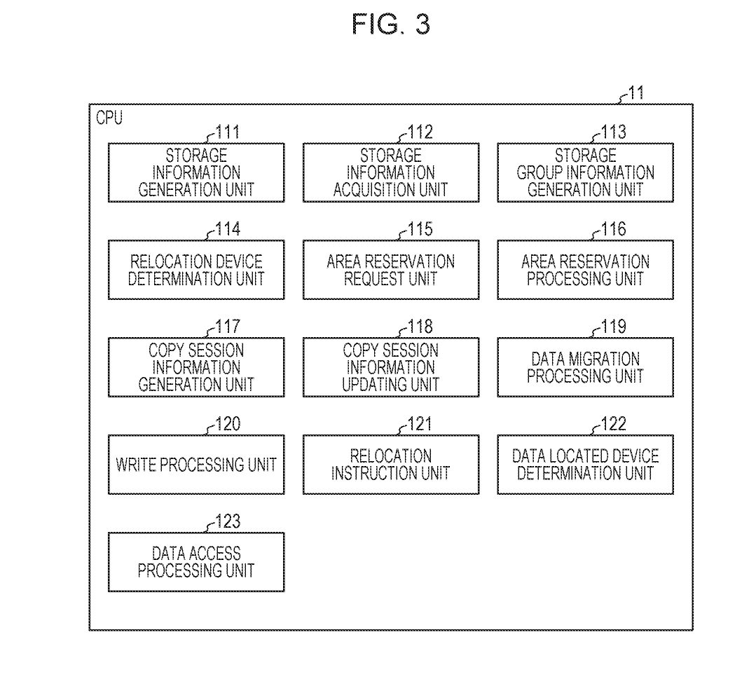

FIG. 3 is a diagram illustrating a configuration of functions implemented by the CPU 11 provided in the CM 10 included in the storage system 100 according to the embodiment.

The CPU 11 is a processing device configured to perform various controls and arithmetic operations. The CPU 11 implements various functions by executing an operating system (OS) or a program stored in the memory 13. That is, as illustrated in FIG. 3, the CPU 11 functions as a storage information generation unit 111, a storage information acquisition unit 112, a storage group information generation unit 113, a relocation device determination unit 114, an area reservation request unit 115, an area reservation processing unit 116, a copy session information generation unit 117, a copy session information updating unit 118, a data migration processing unit 119, a write processing unit 120, a relocation instruction unit 121, a data located device determination unit 122, and a data access processing unit 123.

Programs (control programs) for implementing functions as the storage information generation unit 111, the storage information acquisition unit 112, the storage group information generation unit 113, the relocation device determination unit 114, the area reservation request unit 115, the area reservation processing unit 116, the copy session information generation unit 117, the copy session information updating unit 118, the data migration processing unit 119, the write processing unit 120, the relocation instruction unit 121, the data located device determination unit 122, and the data access processing unit 123 are provided in a mode recorded in a computer-readable recording medium such as, for example, a flexible disk, a compact disc (CD) such as CD-ROM, CD-R, CD-RW, and so on, a digital versatile disc (DVD) such as DVD-ROM, DVD-RAM, DVD-R, DVD+R, DVD-RW, DVD+RW, HD DVD, and so on, a Blu-ray disk, a magnetic disk, an optical disk, an optical magnetic disk, and so on. Then, the computer reads a program from the recording medium via a reading device (not illustrated) and transfers and stores the program into an internal recording device or an external recording device to use the program. Alternatively, the program may be recorded in a storage unit (recording medium) such as, for example, a magnetic disk, an optical disk, and an optical magnetic disk, and may be then provided to the computer from the storage unit via a communication path.

When implementing the function as the storage information generation unit 111, the storage information acquisition unit 112, the storage group information generation unit 113, the relocation device determination unit 114, the area reservation request unit 115, the area reservation processing unit 116, the copy session information generation unit 117, the copy session information updating unit 118, the data migration processing unit 119, the write processing unit 120, the relocation instruction unit 121, the data located device determination unit 122, or the data access processing unit 123, a program stored in an internal storage unit (memory 13 in the embodiment) is executed by a microprocessor (CPU 11 in the embodiment) of the computer. At this time, a program recorded in a recording medium may be read and executed by the computer.

FIG. 4 is a diagram illustrating data relocation processing in the storage system 100 according to the embodiment.

The storage system 100 illustrated in FIG. 4 is similar to the storage system 100 illustrated in FIG. 1. However, for simplification, only one host device 2 is depicted in the storage system 100 illustrated in FIG. 4. Out of the components of the storage device 1, only the virtual volume 14 (virtual volumes #0, #1) of the storage device #0, and the storage units 21 (SSD 21a, on-line disk 21b, and near-line disk 21c) are illustrated, and other components are omitted for simplification.

Hereinafter, when specifying one of the multiple virtual volumes, the virtual volume is referred to as the “virtual volume #0” or “virtual volume #1”. However, when indicating any one of the virtual volumes, the virtual volume is referred to as a “virtual volume 14”.

Hereinafter, the data relocation processing according to an example of the embodiment is described with reference to FIG. 4.

The host device 2 performs the following processing by executing management software.

The host device 2 analyzes access frequency to data stored in the storage unit 21.

On the basis of the analyzed access frequency, the host device 2 instructs the storage device #0 to relocate data stored in an on-line disk 21b of a tier management group #0 into an SSD 21a (A1). In this case, the CPU 11 of the storage device #0 relocates data stored in the on-line disk 21b into the SSD 21a (A2).

On the basis of the analyzed access frequency, the host device 2 instructs the storage device #0 to relocate data stored in an SSD 21a of the tier management group #0 into an on-line disk 21b (A1). In this case, the CPU 11 of the storage device #0 relocates data stored in the SSD 21a into the on-line disk 21b (A3).

On the basis of the analyzed access frequency, the host device 2 instructs the storage device #0 to relocate data stored in a near-line disk 21c of a tier management group #1 into an on-line disk 21b (A1). In this case, the CPU 11 of the storage device #1 relocates data stored in the near-line disk 21c into the on-line disk 21b (A4).

The data relocation processing (A2 to A4) within the same storage device 1 illustrated in FIG. 4 may be performed by using a conventional technique.

Further, in the storage system 100, the host device 2 may instruct relocation of data among multiple storage devices 1 as described below.

That is, on the basis of the analyzed access frequency, the host device 2 instructs the storage device #0 to relocate data stored in an SSD 21a of the tier management group #0 into a near-line disk 21c (A1). In this case, the data migration processing unit 119 of the storage device #0 relocates data stored in the SSD 21a into the near-line disk 21c (A5).

On the basis of the analyzed access frequency, the host device 2 instructs the storage device #0 to relocate data stored in an SSD 21a of the tier management group #1 into a near-line disk 21c (A1). In this case, the data migration processing unit 119 of the storage device #0 relocates data stored in the SSD 21a into the near-line disk 21c (A6).

On the basis of the analyzed access frequency, the host device 2 instructs the storage device #0 to relocate data stored in an SSD 21a of the tier management group #1 into an on-line disk 21b (A1). In this case, the data migration processing unit 119 of the storage device #0 relocates data stored in the SSD 21a into the on-line disk 21b (A7).

On the basis of the analyzed access frequency, the host device 2 instructs the storage device #0 to relocate data stored in a near-line disk 21c of the tier management group #0 into an on-line disk 21b (A1). In this case, the data migration processing unit 119 of the storage device #1 relocates data stored in the near-line disk 21c into the on-line disk 21b (A8).

On the basis of the analyzed access frequency, the host device 2 instructs the storage device #0 to relocate data stored in an on-line disk 21b of the tier management group #1 into an SSD 21a (A1). In this case, the data migration processing unit 119 of the storage device #1 relocates data stored in the on-line disk 21b of the tier management group #1 into the SSD 21a (A9).

Data relocation processing among multiple storage devices 1 (A5 to A9) illustrated in FIG. 4 is performed by using the remote equivalent copy (REC: inter-device copy) function via the switch 3 (A10). That is, the storage system 100 according to an example of the embodiment expands a tiering control range closed within the same storage device 1 to perform tiering control across storage devices 1, for example, by using a synchronous REC function. The inter-device copy is a copy of data by communication control among multiple storage devices 1 (housings) connected via external communication lines without an intervening upper-level device such as the host device 2.

The storage information generation unit 111 generates tier group information 135 on the storage unit 21 provided in its own storage device 1. The storage information generation unit 111 stores generated tier group information 135 into the memory 13. Hereinafter, the “own storage device 1” refers to a storage device 1 including the CPU 11 implementing the function described herein.

The storage information acquisition unit 112 acquires, from another storage device 1, the tier group information 135 generated by the storage information generation unit 111 of the other storage device 1. The storage information acquisition unit 112 acquires the tier group information 135 from the other storage device 1, for example, by using the REC function. The storage information acquisition unit 112 stores the acquired tier group information 135 into the memory 13. Hereinafter, the “another storage device 1” refers to a storage device 1 different from the storage device 1 including the CPU 11 implementing the function described herein.

FIG. 5 is a diagram illustrating an example of a tier group table in the storage system 100 according to the embodiment.

The tier group table illustrated in FIG. 5 depicts the tier group information 135 in a table format for understanding.

The tier group information 135 is information for grouping storage units 21 by the type of the storage unit 21, the RAID type, and so on. In other words, in the tier group information 135, information on the storage units 21 of the storage device 1 is managed by grouping storage units 21 depending on the data access performance.

The tier group table includes a storage device identifier (ID), a group number, a RAID type, a constituent disk type, and a disk rotation speed.

The storage device ID is identification information uniquely identifying the storage device 1 including the storage unit 21.

The group number is a number for uniquely identifying the tier group within the storage device 1.

The RAID type indicates a RAID type of a RAID constituting the tier group. The RAID type includes, for example, RAID1, RAID1+0, RAIDS, or RAID6.

The constituent disk type indicates a disk type of disks in a RAID constituting the tier group. The constituent disk type includes, for example, an SSD, an on-line disk or a near-line disk.

The disk rotation speed indicates a disk rotation speed when the disks in the RAID constituting the tier group are HDDs. Instead of the disk rotation speed, the tier group table may include a value, such as a seek time, indicating performance value of an HDD.

When the storage information generation unit 111 generates the tier group information 135 and the storage information acquisition unit 112 acquires the tier group information 135, tier groups 101 illustrated in FIG. 4 are defined in the storage device 1. Specifically, two highest speed tier groups 101 and one high speed tier group 101 are defined in the storage device #0, and two low speed tier groups 101 and one high speed tier group 101 are defined in the storage device #1.

The tier group 101 is a unit of multiple RAID groups grouped for each of RAID types and constituent disk types in each of storage devices 1. The virtual volume 14 is physically allocated with the tier group 101 to store data.

In the example illustrated in FIG. 4, a highest speed tier group 101 includes multiple SSDs 21a, a high speed tier group 101 includes multiple on-line disks 21b, and a low speed tier group 101 includes multiple near-line disks 21c. In the example illustrated in FIG. 4, each of the tier groups 101 includes two or three storage units 21. However, the number of storage units 21 in each of the tier groups 101 is not limited thereto and may be changed variously.

The storage group information generation unit 113 generates tier management group information 136 on the basis of the tier group information 135 generated by the storage information generation unit 111 and acquired by the storage information acquisition unit 112. The storage group information generation unit 113 stores the generated tier management group information 136 into the memory 13.

The tier management group information 136 is information for grouping and managing multiple tier group information 135.

On the basis of a setting by the operator, the storage group information generation unit 113 generates tier management group information 136 including multiple tier group information 135. The tier management group information 136 preferably includes not only tier group information 135 of the same level but also tier group information 135 of different levels.

The storage group information generation unit 113 may define priority of the tier group information 135 within the tier management group information 136, on the basis of the data access performance of the storage units 21 included in the multiple tier group information 135 in the tier management group information 136. The priority is set, for example, depending on the RAID disk type, RAID configuration, and so on registered in the tier group information 135 included in the tier management group information 136, and indicates the order of the tier group 101 used for high speed access to data. In a data access to a storage unit 21 of another storage device 1, the inter-device communication incurs overhead. That is, even for tier group information 135 having the same disk type and the RAID configuration, there is a difference in the data access performance between a storage unit 21 of the own storage device 1 and a storage unit 21 of another storage device 1. Therefore, even for the tier group information 135 having the same disk type and the RAID configuration, the priority of the tier group information 135 on the own storage device 1 may be set higher than the tier group information 135 on another storage device 1. This enables the host device 2 to instruct data relocation efficiently.

The storage group information generation unit 113 may generate the tier management group information 136 in its own storage device 1 independently from the tier management group information 136 in another storage device 1. That is, the tier group information 135 included in the other tier management group information 136 by the other storage device 1 may be included in the tier management group information 136 newly generated by the own storage device 1.

When the storage group information generation unit 113 generates the tier management group information 136, tier management groups 102 (tier management groups #0, #1) illustrated in FIG. 4 are defined in the storage system 100.

Hereinafter, when specifying one of multiple tier management groups, the tier management group is referred to as “tier management group #0” or “tier management group #1”. When indicating any one of the tier management groups, the tier management group is referred to as a “tier management group 102”.

A tier management group 102 is a management group that manages multiple tier groups 101, and is defined across multiple storage devices 1. The tier management group 102 is set for each of virtual volumes 14 associated across storage units 21 provided in multiple storage devices 1. In the example illustrated in FIG. 4, tier management groups #0, #1 correspond to virtual volumes #0, #1, respectively.

According to an example of the embodiment, the host device 2 instructs the storage device 1 to change an address in the virtual volume 14 where data is located, on the basis of the access frequency to the data. Thus, the storage device 1 relocates data between storage units 21 associated with the address of the virtual volume 14.

In the example illustrated in FIG. 4, the tier management group #0 includes a highest speed tier group 101 and a high speed tier group 101 defined in the storage device #0, and a low speed tier group 101 defined in the storage device #1. The tier management group #1 includes a highest speed tier group 101 defined in the storage device #0, and a low speed tier group 101 and a high speed tier group 101 defined in the storage device #1.

When data relocation between storage units 21 is instructed, the relocation device determination unit 114 determines a storage device 1 including a storage unit 21 of the relocation source of data, and a storage device 1 including a storage unit 21 of the relocation destination of the data. As illustrated in FIG. 4, data relocation instruction is issued by the host device 2 to the storage device 1 (A1).

The relocation device determination unit 114 reads out the tier management group information 136 generated by the storage group information generation unit 113 from the memory 13. Then, on the basis of the read tier management group information 136, the relocation device determination unit 114 determines the relocation source and the relocation destination of the data.

Also, on the basis of the session information 137 described below with reference to FIG. 6, the relocation device determination unit 114 determines the relocation source and the relocation destination of the data.

The area reservation request unit 115 requests another storage device 1 to reserve an area for storing data in a storage unit 21 of the relocation destination. The area reservation request unit 115 makes the request to reserve the area, when the relocation device determination unit 114 determines that the storage unit 21 of the relocation source is provided in the own storage device 1 and that the storage unit 21 of the relocation destination is provided in the other storage device 1.

The area reservation processing unit 116 reserves an area for storing data in the storage unit 21 of the relocation destination. The area reservation processing unit 116 reserves the area when the relocation device determination unit 114 determines that the storage unit 21 of the relocation source is provided in another storage device 1 and the storage unit 21 of the relocation destination is provided in its own storage device 1. The area reservation processing unit 116 also reserves the area in response to the area reservation request from the area reservation request unit 115 of the other storage device 1.

When an area for storing data to be relocated is reserved by the area reservation processing unit 116 of its own or another storage device 1, the copy session information generation unit 117 generates session information 137 (copy session information). Session information 137 is information for managing copy processing by the REC. Similar session information 137 is generated in the storage device 1 of the data relocation source and the storage device 1 of the data relocation destination. The copy session information generation unit 117 stores generated session information 137 into the memory 13.

FIG. 6 is a diagram illustrating an example of a session table in the storage system 100 according to the embodiment.

The session table illustrated in FIG. 6 depicts the session information 137 in a table format for understanding.

The session table includes, for example, a session ID, a state, a phase, a role, a connected device ID, a virtual volume number, a virtual volume start logical block address (LBA), a chunk size, a copy source number, a copy source copying start LBA, a copy destination number, a copy destination copying start LBA, and a copy size.

The session ID is identification information uniquely identifying the session.

The state indicates a state of the session.

The phase indicates a state of the copy, that is, whether in the process of copying or not.

The role indicates the direction of the REC. Specifically, information as to whether its own storage device 1 is a copy source (relocation source) or a copy destination (relocation destination) in the session is registered in the role.

The connected device ID is a storage device ID of another storage device 1 that transmits or receives data by the REC.

The virtual volume number indicates a virtual volume number of the data migration source (relocation source). For example, the virtual volume number in A5 of FIG. 4 is #0, and the virtual volume number in A6 of FIG. 4 is #1.

The virtual volume start LBA is a start LBA of a chunk of the migration source of the virtual volume.

The chunk size represents a size per chunk.

The copy source number is physical information indicating the volume number of the copy source.

The copy source copying start LBA is physical information indicating the copying start LBA of the copy source.

The copy destination number is physical information indicating the volume number of the copy destination.

The copy destination copying start LBA is physical information indicating the copying start LBA of the copy destination.

The copy size represents a size from the copy source copying start LBA to the copy destination copying start LBA. According to an example of the embodiment, the copy size is the size of one chunk.

The copy session information updating unit 118 updates the session information 137 generated by the copy session information generation unit 117. Specifically, when relocation is instructed for data of which session information 137 has been generated, the copy session information updating unit 118 updates the session information 137 so as to indicate a state in which the relocation processing is completed.

When the area of the data relocation destination is reserved by the area reservation processing unit 116 of another storage device 1, the data migration processing unit 119 migrates data by copying data to the other storage device 1 with the REC function. The data migration processing unit 119 migrates the data via the switch 3 illustrated in FIGS. 1 and 4.

After having copied data with the REC function, the data migration processing unit 119 releases the area of the relocation source by deleting the relocated data from the area of the storage unit 21 of the relocation source.

The write processing unit 120 writes, into the storage unit 21 of the relocation destination, data obtained by data copy to its own storage device 1 performed by another storage device 1 using the REC function. When the area of the data relocation destination is reserved by the area reservation processing unit 116 of the own storage device 1, the write processing unit 120 writes the data into the storage unit 21.

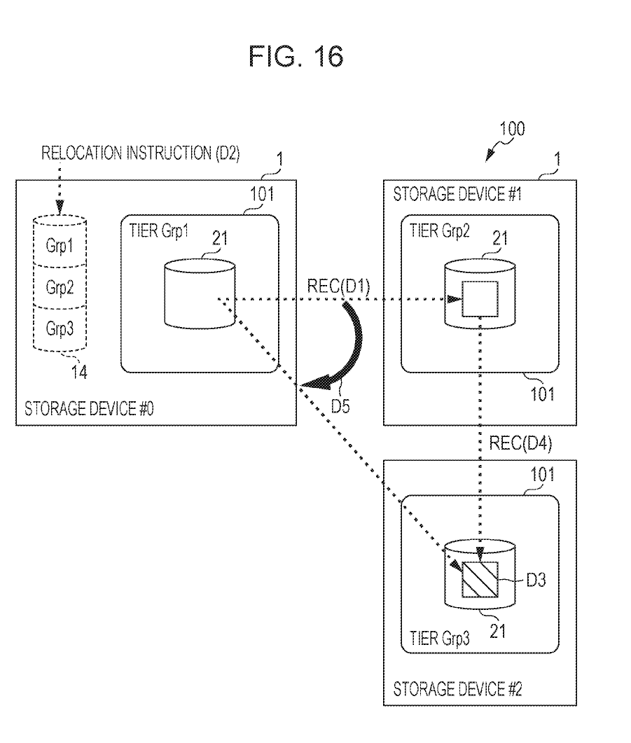

As described below with reference to FIG. 16, the relocation instruction unit 121 functions when the storage system 100 includes three storage devices 1 (storage devices #0 to #2).

Hereinafter, when specifying one of the multiple storage devices, the storage device is referred to as “storage device #0”, “storage device #1”, or “storage device #2. However, when indicating any one of the storage devices, the storage device is referred to as a “storage device 1”.

When a determination result by the relocation device determination unit 114 satisfies a predetermined condition, the relocation instruction unit 121 of the storage device #0 issues a data relocation instruction to another storage device #1 (or #2) to relocate data from the other storage device #1 (or #2) to yet another storage device #2 (or #1). The predetermined condition is determination by the relocation device determination unit 114 that the storage unit 21 of the relocation source is provided in another storage device #1 (or #2) and the storage unit 21 of the relocation destination is provided in yet another storage device #2 (or #1). The relocation instruction unit 121 of storage devices #1, #2 also has similar function as the relocation instruction unit 121 of the storage device #0.

When a read access request or a write access request to data is made from the host device 2, the data located device determination unit 122 determines a storage device 1 including a storage unit 21 in which the data is located.

The data access processing unit 123 makes read data access or write data access to the storage unit 21 included in the storage device 1 determined by the data located device determination unit 122. Specifically, when the data located device determination unit 122 has determined that data is located in a storage unit 21 provided in its own storage device 1, the data access processing unit 123 makes data access to the storage unit 21 provided in the own storage device 1. When the data located device determination unit 122 has determined that data is not located in a storage unit 21 provided in the own storage device 1, the data access processing unit 123 makes data access to a storage unit 21 provided in another storage device 1. The data access processing unit 123 reserves a buffer memory for storing write data in the memory 13 and performs data write processing into the reserved buffer memory. Then, the data access processing unit 123 performs the REC to the other storage device 1 using the buffer memory into which the data has been written as a copy source, and releases the reserved buffer memory after completion of the REC. Also, the data access processing unit 123 reserves a buffer memory for storing read data in the memory 13, and writes, into the reserved buffer memory, data obtained from the other storage device 1 with the REC. Then, the data access processing unit 123 reads data written into the buffer memory, and releases the reserved buffer memory after completion of the reading.

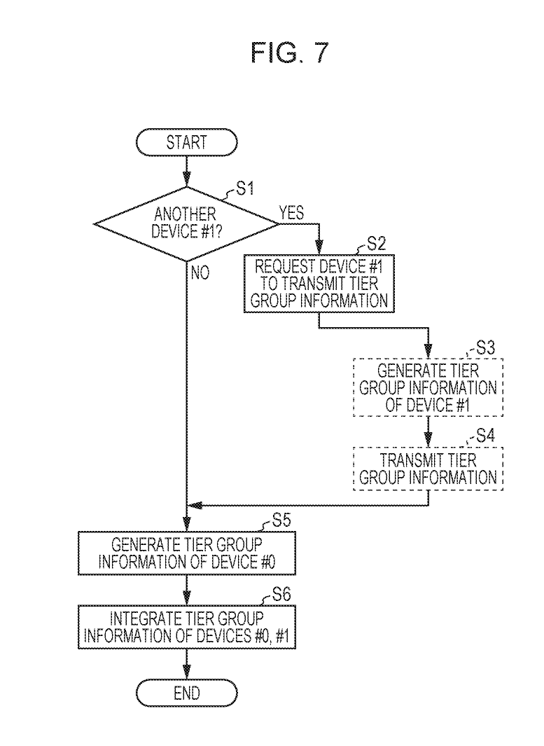

Tier group information generation processing in the storage system 100 according to the embodiment is described with reference to a flowchart illustrated in FIG. 7.

Hereinafter, in flowcharts illustrated in FIGS. 7 to 9, 11, 12, 14, and 15, an example of the storage system 100 including two storage devices #0, #1 as illustrated in FIGS. 1 and 4 is described. Hereinafter, in flowcharts illustrated in FIGS. 7, 8, 11, 12, 14, and 15, processing indicated with a solid line represents processing by the storage device #0, and processing indicated with a broken line represents processing by the storage device #1.

For example, upon receiving from the host device 2 an acquisition instruction of the tier group information 135, the storage information acquisition unit 112 of the storage device #0 determines whether another storage device #1 is connected to its own storage device #0 (S1 of FIG. 7). For example, the storage information acquisition unit 112 of the storage device #0 determines whether the other storage device #1 is connected, by reading configuration information (not illustrated) held by the own storage device #0.

When the other storage device #1 is not connected (S1 of FIG. 7: No), the process shifts to S5.

When the other storage device #1 is connected (S1 of FIG. 7: Yes), the storage information acquisition unit 112 of the storage device #0 requests the other storage device #1 to transmit the tier group information 135 (S2 of FIG. 7). For example, the storage information acquisition unit 112 of the storage device #0 transmits an acquisition command of the tier group information 135 to the connected storage device #1 by utilizing a communication path via the switch 3 which is a communication path for the REC.

In response to the transmission request of the tier group information 135 by the storage information acquisition unit 112 of the storage device #0, the storage information generation unit 111 of the storage device #1 generates the tier group information 135 in its own storage device #1 (S3 of FIG. 7).

The storage information generation unit 111 of the storage device #1 transmits the generated tier group information 135 to the storage device #0 (S4 of FIG. 7).

The storage information generation unit 111 of the storage device #0 generates the tier group information 135 in its own storage device #0 (S5 of FIG. 7).

The storage information generation unit 111 of the storage device #0 integrates the generated tier group information 135 in the own storage device #0 and the received tier group information 135 in the other storage device #1 (S6 of FIG. 7), and the process ends. When the own storage device #0 is not connected to the other storage device #1, integrated tier group information 135 includes only the generated tier group information 135 in the own storage device #0.

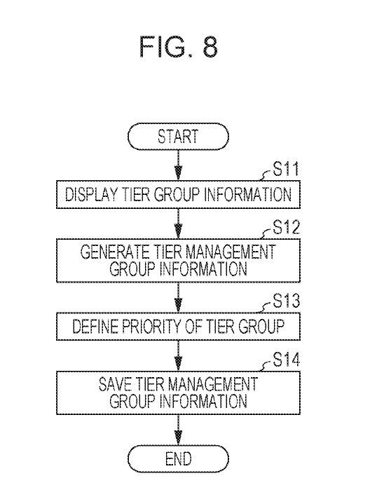

Next, tier group information generation processing in the storage system 100 according to the embodiment is described with reference to a flowchart illustrated in FIG. 8.

The storage group information generation unit 113 of the storage device #0 transmits the tier group information 135 integrated by the storage information generation unit 111 in S6 of FIG. 7, for example, to the host device 2 to cause a display unit (not illustrated) provided in the host device 2 to display the transmitted tier group information 135 (S11 of FIG. 8).

In response to input by the operator via an input device (not illustrated) provided in the host device 2, for example, the storage group information generation unit 113 generates tier management group information 136 including multiple tier group information 135 (S12 of FIG. 8).

The storage group information generation unit 113 defines the priority of the tier group information 135 within the tier management group information 136, on the basis of the data access performance of the storage unit 21 included in the multiple tier group information 135 in the tier management group information 136 (S13 of FIG. 8).

The storage group information generation unit 113 stores the tier management group information 136 in which the priority is defined, into the memory 13 (S14 of FIG. 8), and the process ends.

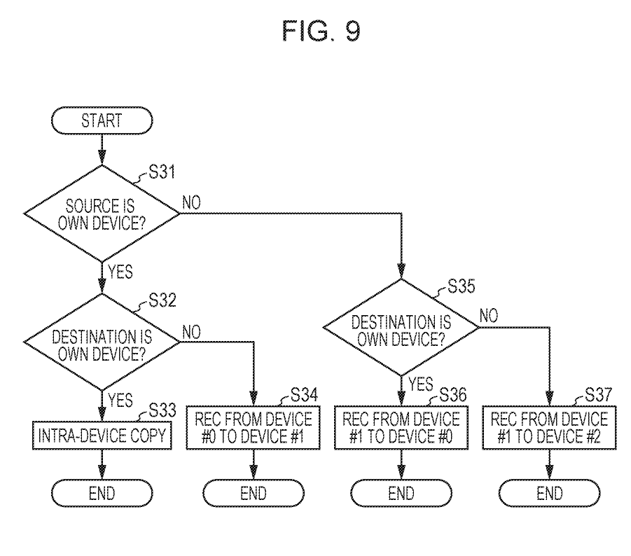

Next, relocation device determination processing in the storage system 100 according to the embodiment is described with reference to a flowchart illustrated in FIG. 9.

In the flowchart illustrated in FIG. 9, it is assumed that the storage system 100 includes three storage devices 1 (storage devices #0 to #2) as described below with reference to FIG. 16. The flowchart illustrated in FIG. 9 indicates processing in the storage device #0.

The relocation device determination unit 114 of the storage device #0 determines whether the storage device 1 including the storage unit 21 of the relocation source is its own storage device #0 (S31 of FIG. 9).

If the relocation source is the own storage device #0 (S31 of FIG. 9: Yes), the relocation device determination unit 114 determines whether the storage device 1 including the storage unit 21 of the relocation destination is the own storage device #0 (S32 of FIG. 9).

If the relocation destination is the own storage device #0 (S32 of FIG. 9: Yes), the relocation device determination unit 114 determines that the data relocation processing is the intra-device copy in the own storage device #0 (S33 of FIG. 9), and the process ends.

If the relocation destination is not the own storage device #0 (S32 of FIG. 9: No), the relocation device determination unit 114 determines that data relocation processing is the REC from the own storage device #0 to another storage device #1 (or #2) (S34 of FIG. 9). Then, the process ends.

If the relocation source is not the own storage device #0 (S31 of FIG. 9: No), the relocation device determination unit 114 determines whether the storage device 1 including the storage unit 21 of the relocation destination is the own storage device #0 (S35 of FIG. 9).

If the relocation destination is the own storage device #0 (S35 of FIG. 9: Yes), the relocation device determination unit 114 determines that the data relocation processing is the REC from another storage device #1 (or #2) to the own storage device #0 (S36 of FIG. 9). Then, the process ends.

If the relocation destination is not the own storage device #0 (S35 of FIG. 9: No), the relocation device determination unit 114 determines that the data relocation processing is the REC from another storage device #1 (or #2) to yet another storage device #2 (or #1) (S37 of FIG. 9). Then, the process ends.

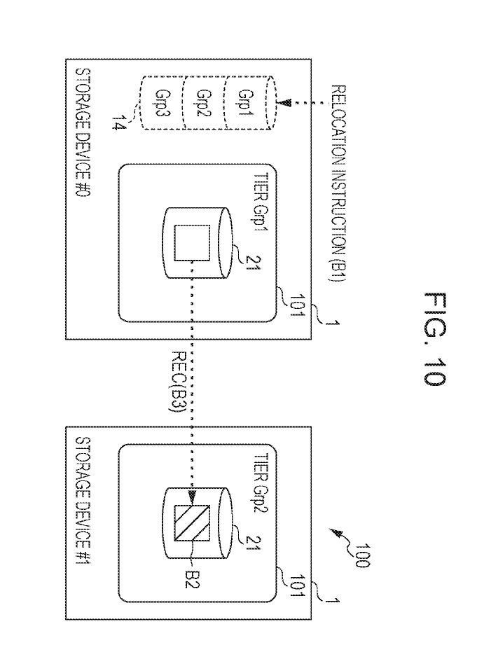

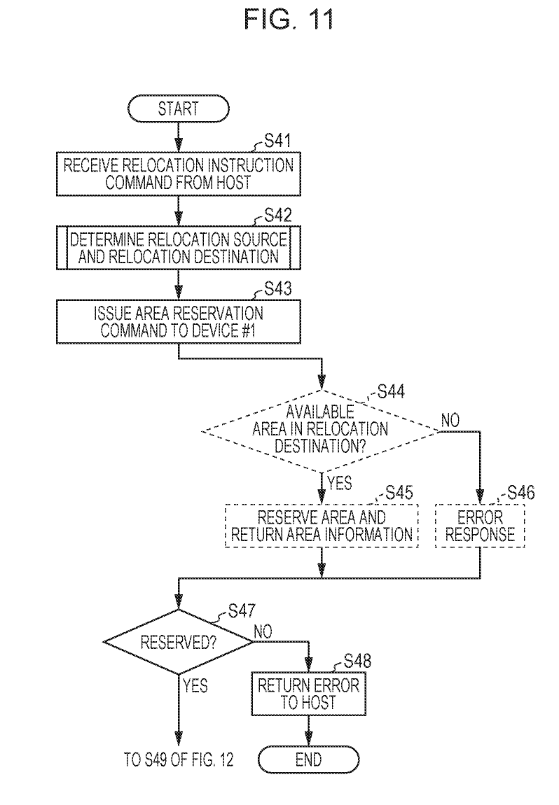

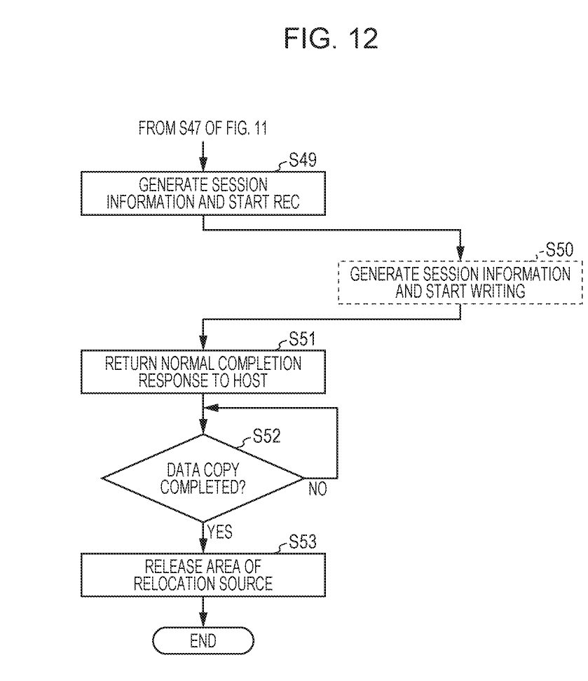

Next, a first example of the data relocation processing in the storage system 100 according to the embodiment is described with reference to FIG. 10 and flowcharts illustrated in FIGS. 11 and 12. Specifically, the data relocation processing from the own storage device #0 to the other storage device #1 is described.

FIG. 10 is a diagram illustrating a first example of the data relocation processing in the storage system 100 according to the embodiment.

The storage system 100 illustrated in FIG. 10 is similar to the storage system 100 illustrated in FIG. 1. However, the host device 2 and the switch 3 provided in the storage system 100 are omitted in FIG. 10 for simplification. Also, out of the components included in the storage device #0, only the virtual volume 14 and the storage unit 21 are illustrated, and out of the components included in the storage device #1, only the storage unit 21 is illustrated. Other components are omitted for simplification.

In the example illustrated in FIG. 10, the virtual volume 14 deployed by the storage device #0 is divided into three tier group areas (Tier Grp1, Tier Grp2, and Tier Grp3) depending on the data access performance of the corresponding storage unit 21. It is assumed that the Tier Grp1 to Tier Grp 3 belong to the same tier management group 102. In the example illustrated in FIG. 10, an example of relocating data from the Tier Grp1 of its own storage device #0 to the Tier Grp2 of another storage device #1 is described.

The relocation device determination unit 114 of the storage device #0 receives a relocation instruction command from the host device 2 (B1 of FIG. 10 and S41 of FIG. 11). Specifically, the relocation device determination unit 114 receives a relocation instruction command issued by the host device 2 instructing to relocate data stored in an area of the Tier Grp1 of the virtual volume 14 into an area of the Tier Grp2.

The relocation device determination unit 114 of the storage device #0 determines a storage device 1 including a storage unit 21 of the data relocation source, and a storage device 1 including a storage unit 21 of the data relocation destination by performing the relocation device determination processing described with reference to the flowchart of FIG. 9 (S42 of FIG. 11). In the example illustrated in FIGS. 10 and 11, the relocation device determination unit 114 determines that the relocation source is its own storage device #0, and the relocation destination is another storage device #1. That is, as illustrated in S34 of FIG. 9, the relocation device determination unit 114 determines that the data relocation processing is the REC from its own storage device #0 to another storage device #1.

The area reservation request unit 115 of the storage device #0 requests to reserve an area for storing the relocation target data in the storage unit 21 of the relocation destination by issuing an area reservation command (S43 of FIG. 11). Specifically, the area reservation request unit 115 designates the group number (see FIG. 5) of the tier group information 135 (tier group table) of the Tier Grp2 designated as the data relocation destination by the host device 2 to issue the area reservation command to the storage device #1.

The area reservation processing unit 116 of the storage device #1 determines whether there is an available area for storing the relocation target data in the storage unit 21 of the relocation destination (S44 of FIG. 11).

If there is an available area in the storage unit 21 of the relocation destination (S44 of FIG. 11: Yes), the area reservation processing unit 116 of the storage device #1 reserves an area for storing the relocation target data in the storage unit 21 of Tier Grp2 (B2 of FIG. 10). Then, the area reservation processing unit 116 returns area information indicating an address and so on of the reserved area to the storage device #0 (S45 of FIG. 11), and the process shifts to S47.

When there is no available area in the storage unit 21 of the relocation destination (S44 of FIG. 11: No), the area reservation processing unit 116 of the storage device #1 returns error indicating the area shortage in the storage unit 21 of the relocation destination to the storage device #0 (S46 of FIG. 11).

The area reservation request unit 115 of the storage device #0 receives the response of area information from the storage device #1, and determines whether the area is successfully reserved in the storage unit 21 of the relocation destination (S47 of FIG. 11).

When the area is not reserved (S47 of FIG. 11: No), the area reservation request unit 115 of the storage device #0 returns error to the relocation instruction command issued by the host device 2 (S48 of FIG. 11). Then, the process ends.

When the area is reserved (S47 of FIG. 11: Yes), the copy session information generation unit 117 of the storage device #0 generates session information 137, and the data migration processing unit 119 starts the REC processing (B3 of FIG. 10 and S49 of FIG. 12). Specifically, the copy session information generation unit 117 generates the session information 137 by designating the copy destination on the basis of the area information for the storage unit 21 of the relocation destination received from the storage device #1. Then, the data migration processing unit 119 starts the copy processing of relocation target data by the REC function and instructs the storage device #1 to generate session information 137.

The copy session information generation unit 117 of the storage device #1 generates the session information 137 and responds to the storage device #0. The write processing unit 120 starts writing of data received from the storage device #0 by the REC processing into the storage unit 21 of the relocation destination (S50 of FIG. 12).

The data migration processing unit 119 of the storage device #0 returns a normal completion response of the data relocation processing to the relocation instruction command issued by the host device 2 (S51 of FIG. 12).

The data migration processing unit 119 of the storage device #0 determines whether data copy to the storage device #1 by the REC function has been completed (S52 of FIG. 12).

If data copy has not been completed (S52 of FIG. 12: No), the data migration processing unit 119 of the storage device #0 repeats the processing of S52 until completion of data copy.

If data copy has been completed (S52 of FIG. 12: Yes), the data migration processing unit 119 of the storage device #0 releases the area of the relocation source by deleting the relocation target data from the area in the storage unit 21 of the relocation source (S53 of FIG. 12). Then, the process ends.

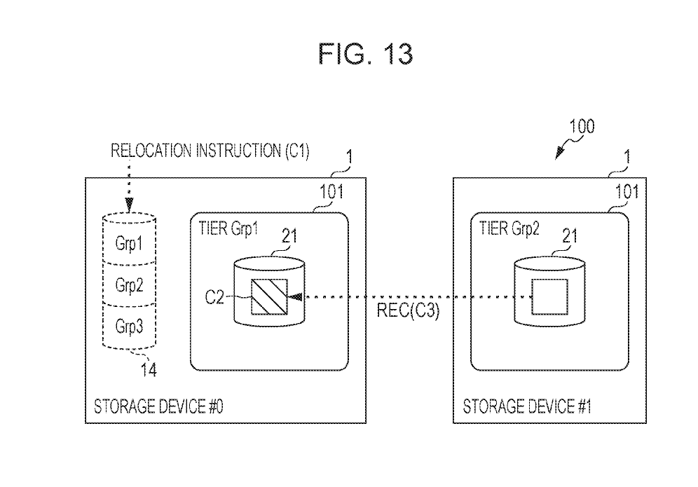

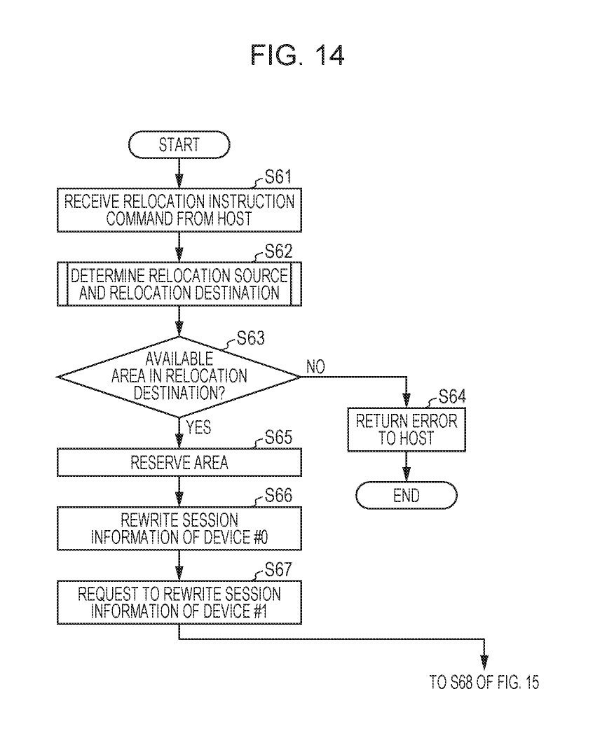

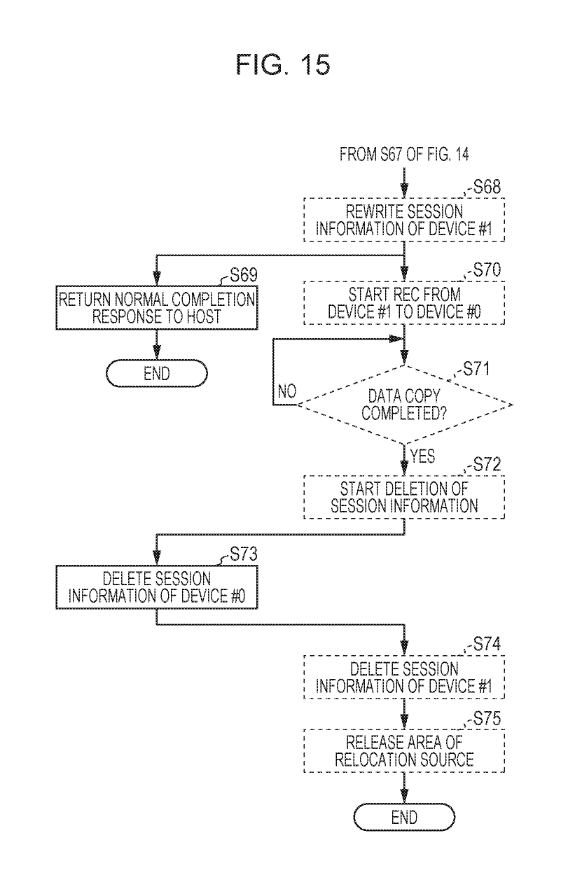

Next, a second example of the data relocation processing in the storage system 100 according to the embodiment is described with reference to FIG. 13 and flowcharts illustrated in FIGS. 14 and 15. Specifically, data relocation processing from another storage device #1 to an own storage device #0 is described.

FIG. 13 illustrates the second example of the data relocation processing in the storage system 100 according to the embodiment.

The storage system 100 illustrated in FIG. 13 is similar to the storage system 100 illustrated in FIG. 10. In the example illustrated in FIG. 13, an example of relocating data from the Tier Grp2 of the other storage device #1 to the Tier Grp1 of the own storage device #0 is described.

The relocation device determination unit 114 of the storage device #0 receives a relocation instruction command from the host device 2 (C1 of FIG. 13 and S61 of FIG. 14). Specifically, the relocation device determination unit 114 receives a relocation instruction command instructing to relocate data stored in an area of the Tier Grp2 of the virtual volume 14 issued by the host device 2 into an area of the Tier Grp1.

The relocation device determination unit 114 of the storage device #0 determines a storage device 1 including a storage unit 21 of the data relocation source, and a storage device 1 including a storage unit 21 of the data relocation destination by performing the relocation device determination processing described with reference to the flowchart of FIG. 9 (S62 of FIG. 14). In the example illustrated in FIGS. 13 and 14, the relocation device determination unit 114 determines that the relocation source is the other storage device #1, and the relocation destination is the own storage device #0. That is, as illustrated in S36 of FIG. 9, the relocation device determination unit 114 determines that the data relocation processing is the REC from another storage device #1 to its own storage device #0.

The area reservation processing unit 116 of the storage device #0 determines whether there is an available area for storing the relocation target data in the storage unit 21 of the relocation destination (S63 of FIG. 14).

When there is no available area in the storage unit 21 of the relocation destination (S63 of FIG. 14: No), the area reservation processing unit 116 of the storage device #0 returns error to the relocation instruction command issued by the host device 2 (S64 of FIG. 14), and the process ends.

When there is an available area in the storage unit 21 of the relocation destination (S63 of FIG. 14: Yes), the area reservation processing unit 116 of the storage device #0 reserves an area for storing the relocation target data in the storage unit 21 (C2 of FIG. 13 and S65 of FIG. 14). Specifically, the area reservation processing unit 116 reserves an area of the storage unit 21 belonging to the Tier Grp1 designated as the data relocation destination by the host device 2.

The copy session information updating unit 118 of the storage device #0 rewrites the session information 137 in the own storage device #0 (S66 of FIG. 14). Specifically, the copy session information updating unit 118 updates logical unit number (LUN) information of the virtual volume 14 in the session information 137. Also, the copy session information updating unit 118 reverses the direction of the REC session in the session information 137 by replacing the storage device 1 of the copy source and the storage device 1 of the copy destination with each other.

The copy session information updating unit 118 of the storage device #0 requests the storage device #1 to rewrite the session information 137 (S67 of FIG. 14).

The copy session information updating unit 118 of the storage device #1 rewrites the session information 137 in its own storage device #1 (S68 of FIG. 15). Specifically, the copy session information updating unit 118 updates LUN information of the virtual volume 14 in the session information 137. Also, the copy session information updating unit 118 reverses direction of the REC session in the session information 137 by replacing the storage device 1 of the copy source and the storage device 1 of the copy destination with each other. Then, the copy session information updating unit 118 returns a response of write completion of the session information 137 to the storage device #0.

The copy session information updating unit 118 of the storage device #0 returns a normal completion response of the data relocation processing to the relocation instruction command issued by the host device 2 with (S69 of FIG. 15), and ends processing to the host I/O.

On the other hand, the data migration processing unit 119 of the storage device #1 starts REC processing from the storage device #1 to the storage device #0 in parallel with the processing of S69 (C3 of FIG. 13 and S70 of FIG. 15).

The write processing unit 120 of the storage device #0 starts writing of data received from the storage device #1 by the REC processing into the storage unit 21 of the relocation destination.

The data migration processing unit 119 of the storage device #1 determines whether data copy to the storage device #0 by the REC function has been completed (S71 of FIG. 15).

If data copy has not been completed (S71 of FIG. 15: No), the data migration processing unit 119 of the storage device #1 repeats the processing of S71 until completion of data copy.

If data copy has been completed (S71 of FIG. 15: Yes), the copy session information updating unit 118 of the storage device #1 starts deletion of the session information 137 (S72 of FIG. 15).

The copy session information updating unit 118 of the storage device #0 deletes the session information 137 in its own storage device #0 (S73 of FIG. 15).

The copy session information updating unit 118 of the storage device #1 deletes the session information 137 in its own storage device #1 (S74 of FIG. 15).

The data migration processing unit 119 of the storage device #0 releases the area of the relocation source by deleting the relocation target data from the area in the storage unit 21 of the relocation source (S75 of FIG. 15). Then, the process ends.

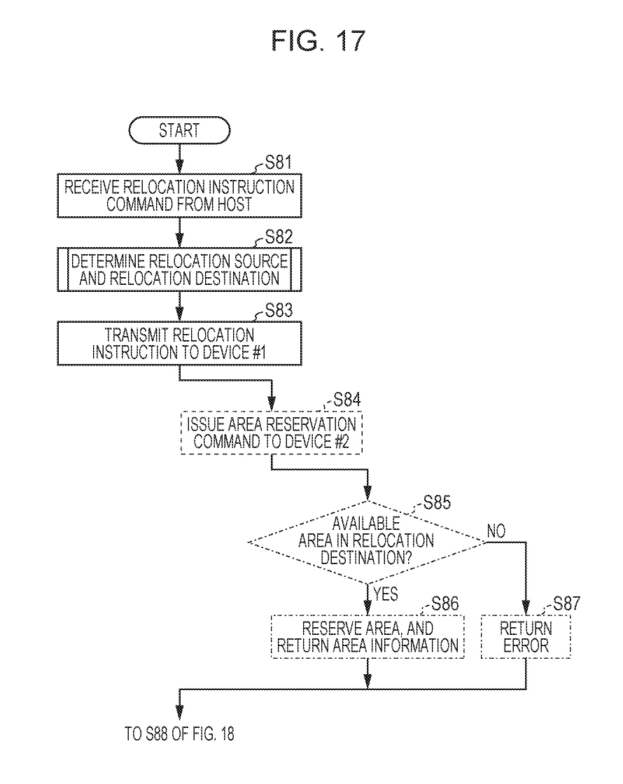

Next, a third example of the data relocation processing in the storage system 100 according to the embodiment is described with reference to FIG. 16 and flowcharts illustrated in FIGS. 17 to 19. Specifically, data relocation processing from another storage device #1 to yet another storage device #2 is described.

FIG. 16 illustrates the third example of the data relocation processing in the storage system 100 according to the embodiment.

The storage system 100 illustrated in FIG. 16 includes a storage device #2 in addition to the storage devices #0, #1 included in the storage system 100 illustrated in FIGS. 10 and 13. In the example illustrated in FIG. 16, an example of relocating data from the Tier Grp2 of the other storage device #1 to the Tier Grp3 of the yet other storage device #2 is described.

Hereinafter, in the flowcharts illustrated in FIGS. 17 to 19, processing indicated with a solid line represents processing by the storage device #0, processing indicated with a broken line represents processing by the storage device #1, and processing indicated by a chain line represents processing by the storage device #2.

In the example illustrated in FIG. 16, the REC processing from the Tier Grp1 of the storage device #0 to the Tier Grp2 of the storage device #1 has been performed (D1 of FIG. 16).

The relocation device determination unit 114 of the storage device #0 receives a relocation instruction command from the host device 2 (D2 of FIG. 16 and S81 of FIG. 17). Specifically, the relocation device determination unit 114 receives a relocation instruction command issued by the host device 2 instructing to relocate data stored in the area of the Tier Grp2 of the virtual volume 14 into an area of the Tier Grp3.

The relocation device determination unit 114 of the storage device #0 determines a storage device 1 including a storage unit 21 of the data relocation source, and a storage device 1 including a storage unit 21 of the data relocation destination by performing the relocation device determination processing described with reference to the flowchart of FIG. 9 (S82 of FIG. 17). In the example illustrated in FIGS. 16 and 17, the relocation device determination unit 114 determines that the relocation source is the other storage device #1, and the relocation destination is the yet other storage device #2. That is, as illustrated in S37 of FIG. 9, the relocation device determination unit 114 determines that the data relocation processing is the REC from another storage device #1 to yet another storage device #2.

The relocation instruction unit 121 of the storage device #0 transmits a data relocation instruction command to the storage device #1 (S83 of FIG. 17).

The area reservation request unit 115 of the storage device #1 requests the storage device #2 to reserve an area for storing the relocation target data in the storage unit 21 of the relocation destination by issuing an area reservation command (S84 of FIG. 17). Specifically, the area reservation request unit 115 designates the group number (see FIG. 5) of the tier group information 135 (tier group table) of the Tier Grp3 designated as the data relocation destination by the host device 2 to issue the area reservation command to the storage device #2.

The area reservation processing unit 116 of the storage device #2 determines whether there is an available area for storing the relocation target data in the storage unit 21 of the relocation destination (S85 of FIG. 17).

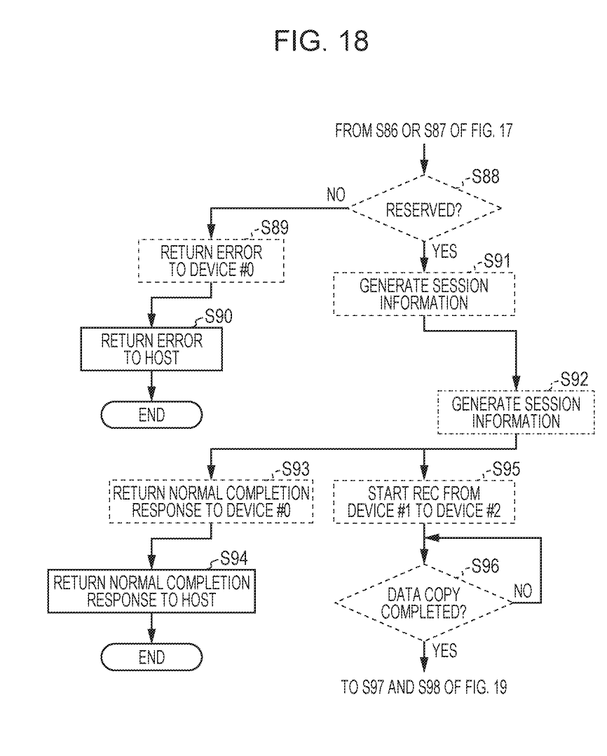

If there is an available area in the storage unit 21 of the relocation destination (S85 of FIG. 17: Yes), the area reservation processing unit 116 of the storage device #2 reserves an area for storing the relocation target data in the storage unit 21 of the Tier Grp3 (D3 of FIG. 16). Then, the area reservation processing unit 116 returns area information indicating an address and so on of the reserved area to the storage device #1 (S86 of FIG. 17), and the process shifts to S88 of FIG. 18.

When there is no available area in the storage unit 21 of the relocation destination (S85 of FIG. 17: No), the area reservation processing unit 116 of the storage device #2 returns error indicating the area shortage in the storage unit 21 of the relocation destination to the storage device #1 (S87 of FIG. 17).

The area reservation request unit 115 of the storage device #1 receives the response of the area information from the storage device #2, and determines whether the area is successfully reserved in the storage unit 21 of the relocation destination (S88 of FIG. 18).

When the area fails to be reserved (S88 of FIG. 18: No), the area reservation request unit 115 of the storage device #1 returns error to the relocation instruction command issued by the storage device #0 (S89 of FIG. 18).

The relocation instruction unit 121 of the storage device #0 returns error to the relocation instruction command issued by the host device 2 (S90 of FIG. 18). Then, the process ends.

In S88 of FIG. 18, when the area is successfully reserved (S88 of FIG. 18: Yes), the copy session information generation unit 117 of the storage device #1 generates session information 137 (S91 of FIG. 18). Specifically, the copy session information generation unit 117 generates the session information 137 by designating the copy destination on the basis of the area information for the storage unit 21 of the relocation destination received from the storage device #2. Then, the copy session information generation unit 117 instructs the storage device #2 to generate session information 137.

The copy session information generation unit 117 of the storage device #2 generates the session information 137 (S92 of FIG. 18) and responds to the storage device #1.

The copy session information generation unit 117 of the storage device #1 returns a normal completion response of the data relocation processing to the relocation instruction command issued by the storage device #0 (S93 of FIG. 18).

The relocation instruction unit 121 of the storage device #0 returns a normal completion response of the data relocation processing to the relocation instruction command issued by the host device 2 (S94 of FIG. 18), and ends processing to the host I/O.

The data migration processing unit 119 of the storage device #1 starts the REC processing from the storage device #1 to the storage device #2 in parallel with the processing of S93 and S94 (D4 of FIG. 16 and S95 of FIG. 18).

The write processing unit 120 of the storage device #2 starts writing of data received from the storage device #1 by the REC processing into the storage unit 21 of the relocation destination.

The data migration processing unit 119 of the storage device #1 determines whether data copy to the storage device #2 by the REC function has been completed (S96 of FIG. 18).

If data copy has not been completed (S96 of FIG. 18: No), the data migration processing unit 119 of the storage device #1 repeats the processing of S96 until completion of data copy.

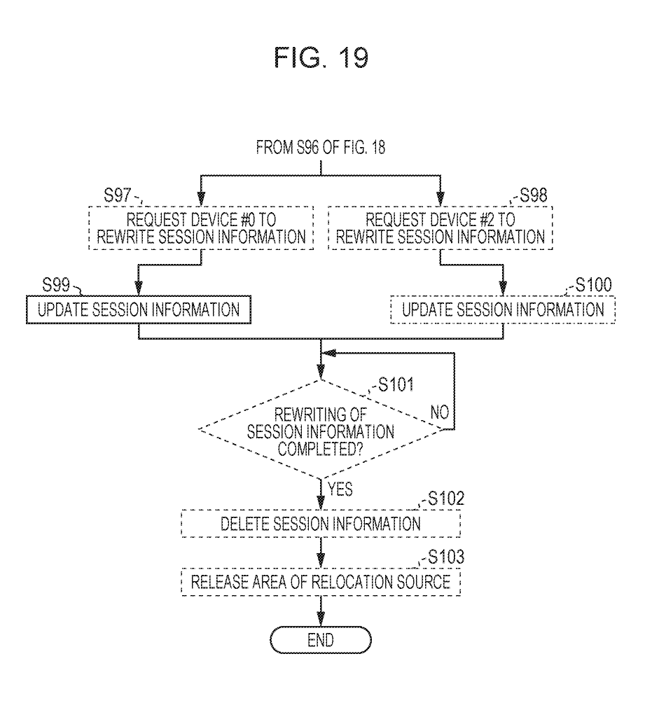

If data copy has been completed (S96 of FIG. 18: Yes), the copy session information updating unit 118 of the storage device #1 requests storage devices #0, #2 to rewrite the session information 137 (S97 and S98 of FIG. 19). Specifically, the copy session information updating unit 118 instructs to rewrite the session information 137 with accompanying, as parameters, the session information 137 to be rewritten held by storage devices #0, #2 and the session information 137 after rewriting. At this time, items to be rewritten in the session information 137 (session table) include, for example, the connected device ID, the copy source number, the copy source copying start LBA, the copy destination number, the copy destination copying start LBA, and the copy size.

The copy session information updating unit 118 of the storage devices #0, #2 rewrites the session information 137 in storage devices #0, #2 respectively (S99 and S100 of FIG. 19). Specifically, the copy session information updating unit 118 updates LUN information of the virtual volume 14 in the session information 137. The copy session information updating unit 118 of the storage device #0 updates the storage device 1 of the copy destination from the storage device #1 to the storage device #2 in the session information 137. The copy session information updating unit 118 of the storage device #2 updates the storage device 1 of the copy source from the storage device #1 to the storage device #0 in the session information 137. As the storage device 1 of the copy destination and the storage device 1 of the copy source in the session information 137 are updated by the copy session information updating unit 118 of the storage devices #0, #2, the two-stage REC processing indicated with D1 and D4 in FIG. 16 may be considered as a single REC processing directly performed from the storage device #0 to the storage device #2 (D5 in FIG. 16). Then, the copy session information updating unit 118 returns a response of write completion of the session information 137 to the storage device #0.

The copy session information updating unit 118 of the storage device #0 determines whether rewriting of the session information 137 in the storage devices #0, #1 has been completed (S101 of FIG. 19).

If rewriting of the session information 137 has not yet been completed (S101 of FIG. 19: No), the copy session information updating unit 118 of the storage device #1 repeats the processing of S101 until completion of rewriting of the session information 137.

If rewriting of the session information 137 has been completed (S101 of FIG. 19: Yes), the copy session information updating unit 118 of the storage device #1 deletes the session information 137 in the storage device #1 (S102 of FIG. 19).

The data migration processing unit 119 of the storage device #1 releases the area of the relocation source by deleting the relocation target data from the area in the storage unit 21 of the relocation source (S103 of FIG. 19). Then, the process ends.

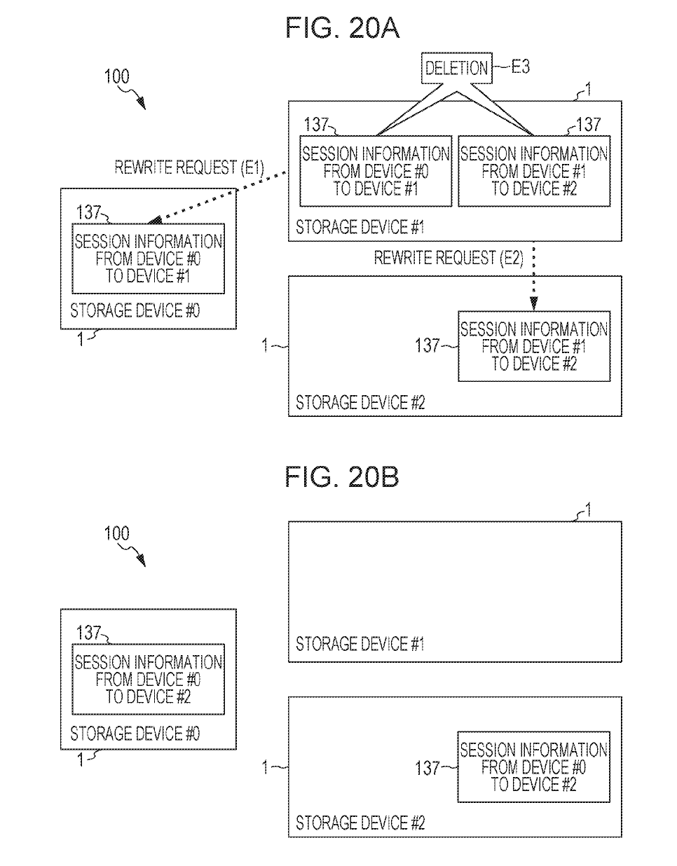

Hereinafter, rewriting and deletion of the session information illustrated in FIG. 19 is described in detail with reference to FIGS. 20A to 24.

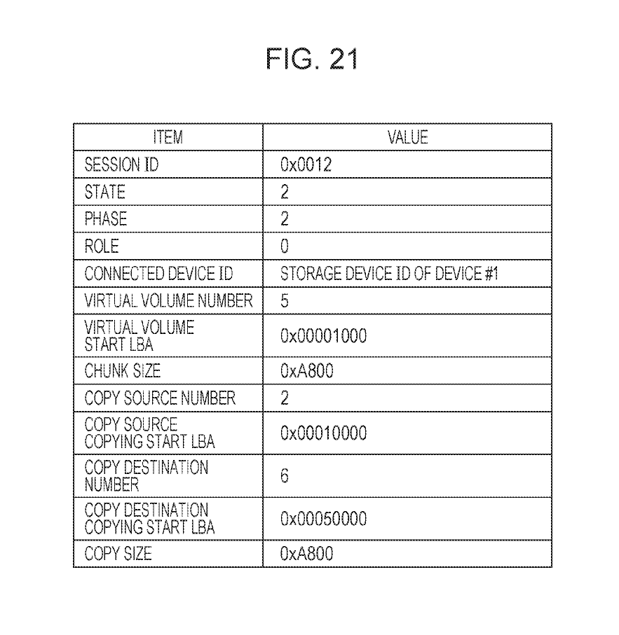

FIG. 20A is a diagram illustrating states of the session tables before rewriting or deletion thereof in the third example of the data relocation processing in the storage system 100 according to the embodiment. FIG. 20B is a diagram illustrating states of the session tables after the rewriting or deletion thereof in the third example of the data relocation processing in the storage system 100 according to the embodiment. FIG. 21 is a diagram illustrating a session table before rewriting thereof, which is used by a storage device of the relocation instruction source in the third example of the data relocation processing in the storage system 100 according to the embodiment.

The session table of FIG. 21 relates to the REC processing which is represented with D1 in FIG. 16 and managed in the storage device #0, in which the relocation source is the storage device #0 and the relocation destination is the storage device #1. Before the session information is updated by the storage device #0 in S99 of FIG. 19, the storage device #0 holds the session information 137 corresponding to the session table illustrated in FIG. 21. The copy source number “2” and the copy source copying start LBA “0x00010000” represent a storage unit 21 provided in its own storage device #0. The copy destination number “6” and the copy destination copying start LBA “0x00050000” represent a storage unit 21 provided in the storage device #1 of the relocation destination.

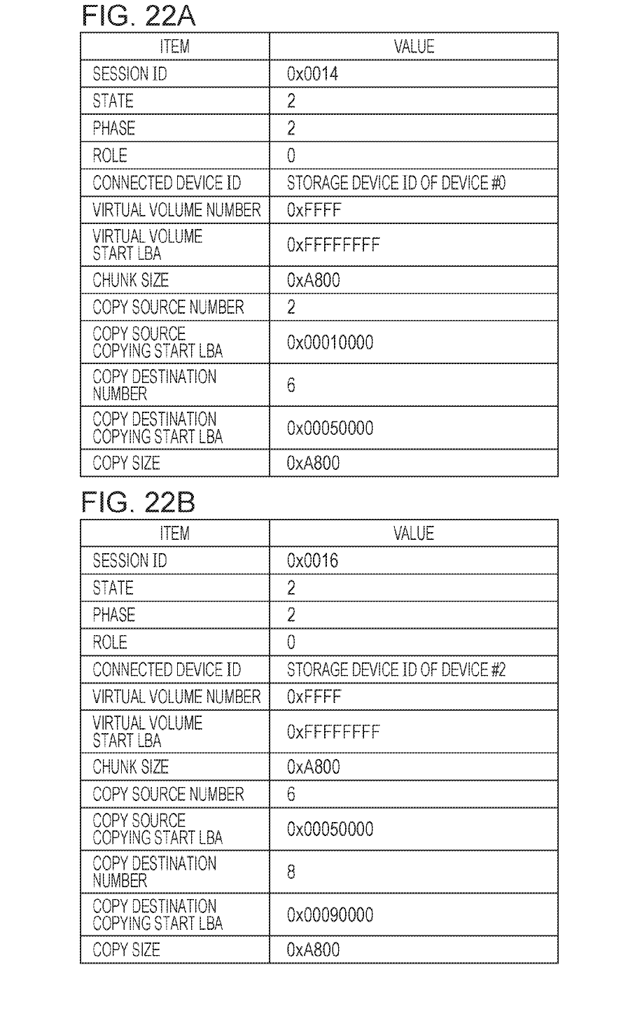

FIG. 22A is a diagram illustrating a session table before the data relocation processing, which is used by a storage device of the relocation source in the third example of the data relocation processing in the storage system 100 according to the embodiment. FIG. 22B is a diagram illustrating the session table after completion of the data relocation processing.

The session table of FIG. 22A relates to the REC processing which is represented with D1 in FIG. 16 and managed in the storage device #1, in which the relocation source is the storage device #0, and the relocation destination is the storage device #1. Before the session information is deleted by the storage device #1 in S102 of FIG. 19, the storage device #1 holds the session information 137 corresponding to the session table illustrated in FIG. 22A. The copy source number “2” and the copy source copying start LBA “0x00010000” represent a storage unit 21 provided in the storage device #0 of the relocation source. The copy source number “6” and the copy source copying start LBA “0x00050000” represent a storage unit 21 provided in its own storage device #1. In the example illustrated in FIG. 16, the virtual volume 14 is managed by the storage device #0. Therefore, the virtual volume number “0xFFFF” and the virtual volume start LBA “0xFFFFFFFF” illustrated in FIG. 22A represent invalid values.

The session table of FIG. 22B relates to the REC processing which is represented with D4 of FIG. 16 and managed in the storage device #1, in which the relocation source is the storage device #1, and the relocation destination is the storage device #2. Before the session information is deleted by the storage device #1 in S102 of FIG. 19, the storage device #1 holds the session information 137 corresponding to the session table illustrated in FIG. 22B. The copy source number “6” and the copy source copying start LBA “0x00050000” represent a storage unit 21 provided in its own storage device #1. The copy source number “8” and the copy source copying start LBA “0x00090000” represent a storage unit 21 provided in the storage device #2 of the relocation destination. In the example illustrated in FIG. 16, the virtual volume 14 is managed by the storage device #0. Therefore, the virtual volume number “0xFFFF” and the virtual volume start LBA “0xFFFFFFFF” illustrated in FIG. 22B represent invalid values.

Before the session information is updated by the storage device #2 in S100 of FIG. 19, the storage device #2 manages a session table similar to the session table illustrated in FIG. 22B. However, in the session table managed by the storage device #2, “storage device ID of device #1” is set as the connected device ID unlike the session table illustrated in FIG. 22B.

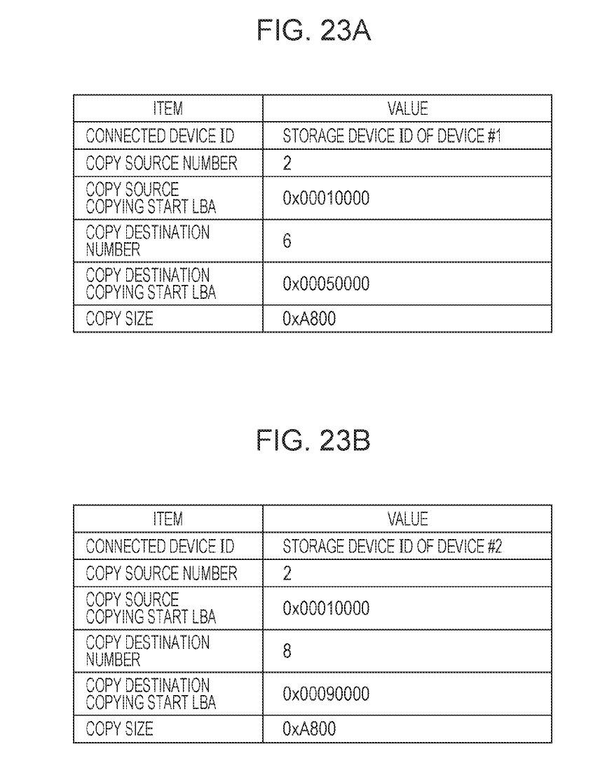

FIG. 23A illustrates data to be rewritten within a session table in the third example of the data relocation processing in the storage system 100 according to the embodiment, and FIG. 23B illustrates data after rewriting.

The copy session information updating unit 118 of the storage device #1 generates a rewrite instruction command including values depicted in FIGS. 23A and 23B by combining session tables illustrated in FIGS. 22A and 22B. Then, the copy session information updating unit 118 requests the storage device #0 to rewrite the session information 137 by transmitting the generated rewrite instruction command (E1 of FIG. 20A). The table in FIG. 23A illustrates items to be rewritten and values thereof within the session table in FIG. 21. The table in FIG. 23B illustrates values of items in FIG. 23A after rewriting.

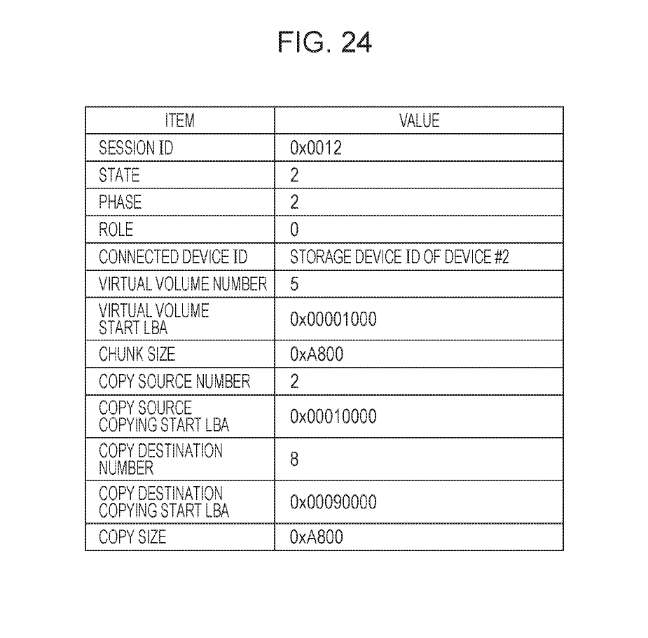

FIG. 24 is a diagram illustrating the session table after rewriting, which is used by a storage device of the relocation instruction source in the third example of the data relocation processing in the storage system 100 according to the embodiment.

On the basis of the rewrite instruction command from the storage device #1, the copy session information updating unit 118 of the storage device #0 rewrites the session table into a state illustrated in FIG. 24. Specifically, the copy session information updating unit 118 searches the memory 13 for the session information 137 to be rewritten, which includes values illustrated in FIG. 23A, and updates the values in the found session information 137 with values illustrated in FIG. 23B. Thus, the copy session information updating unit 118 rewrites the session information 137 such that values of the connected device ID, the copy destination number, and the copy destination copying start LBA represent the storage device #2 as illustrated in FIG. 24.

Upon receiving rewrite request from the storage device #1 (E2 of FIG. 20A), the copy session information updating unit 118 of the storage device #2 rewrites the session information 137 similarly to the storage device #0.

The copy session information updating unit 118 of the storage device #1 deletes two pieces of session information 137 in its own storage device #1 (E3 of FIG. 20A).

By processing represented with E1 to E3 of FIG. 20A, both storage devices #0, #2 hold session information from the storage device #0 to the storage device #2 as illustrated in FIG. 20B. The storage device #1 does not hold the session information 137.

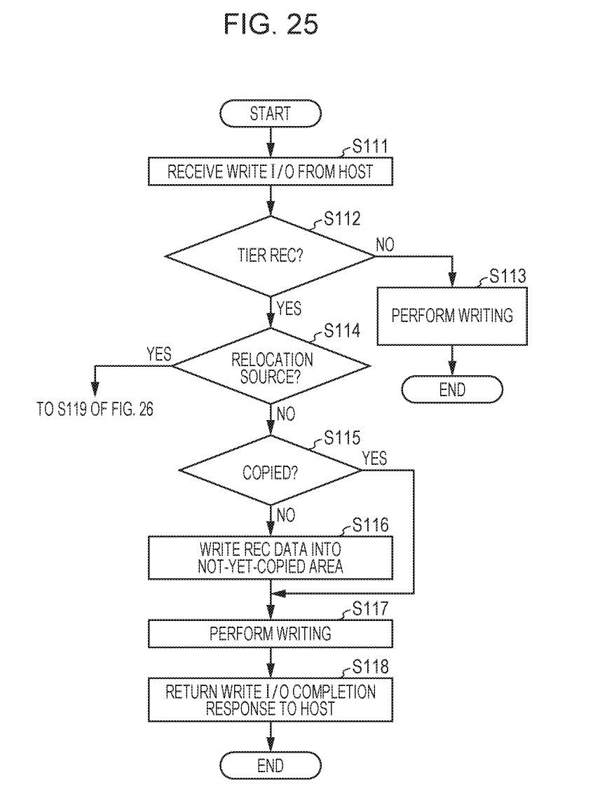

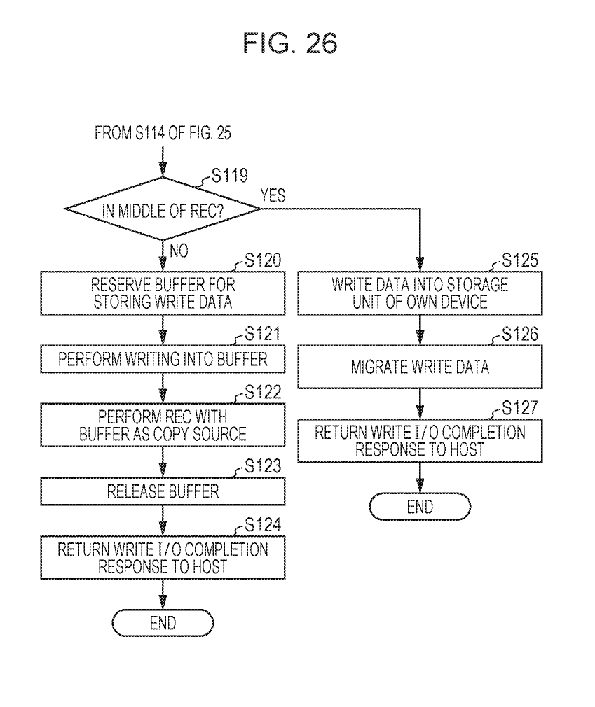

Next, write processing in the storage system 100 according to the embodiment is described with reference to flowcharts illustrated in FIG. 25 and FIG. 26.

The data access processing unit 123 receives a write I/O from the host device 2 (S111 of FIG. 25).

The data located device determination unit 122 determines whether there is a tier REC in the write target area of the virtual volume 14 to which write data access is made (S112 of FIG. 25). That is, the data located device determination unit 122 determines whether the session information 137 is stored in the memory 13 of its own storage device 1 and data relocation processing has been performed between storage devices 1 in the past. For example, the data located device determination unit 122 refers to the virtual volume 14 and access range thereof in which the write processing is performed and the virtual volume number of the session table, the virtual volume start LBA, and the chunk size to determine whether there is a tier REC.

If there is no tier REC (S112 of FIG. 25: No), the data access processing unit 123 performs the write processing to a storage unit 21 provided in its own storage device 1 (S113 of FIG. 25), and the process ends.

If there is a tier REC (S112 of FIG. 25: Yes), the data located device determination unit 122 determines whether its own storage device 1 includes the storage unit 21 of the relocation source in the REC processing (S114 of FIG. 25). The data located device determination unit 122 determines whether the own storage device 1 is the relocation source, for example, with reference to the item “ROLE” of the session table (see FIG. 6).

If the own storage device 1 does not include the storage unit 21 of the relocation source (S114 of FIG. 25: No), the data access processing unit 123 determines whether the write target area has been copied from another storage device 1 (S115 of FIG. 25). The data access processing unit 123 determines whether the read target area has been copied, for example, with reference to the item “PHASE” of the session table (see FIG. 6).

If the write target area has been copied (S115 of FIG. 25: Yes), the process shifts to S117.

If the write target area has not been copied (S115 of FIG. 25: No), the data access processing unit 123 obtains data from the other storage device 1 by REC. Then, the data access processing unit 123 writes the obtained data into the area not yet copied (S116 of FIG. 25).

The data access processing unit 123 performs the write processing to the write target area (S117 of FIG. 25).

The data access processing unit 123 returns a write I/O completion response to the host device 2 (S118 of FIG. 25), and the process ends.

If the own storage device 1 includes the storage unit 21 of the relocation source (S114 of FIG. 25: Yes), the data access processing unit 123 determines whether the REC processing is being performed (S119 of FIG. 26). The data access processing unit 123 determines whether the REC processing is being performed, for example, with reference to the item “STATE” or “PHASE” of the session table (see FIG. 6).

If the REC processing is not being performed (S119 of FIG. 26: No), the data access processing unit 123 reserves a buffer area for storing the write target data, for example, in the memory 13 of the own storage device 1 (S120 of FIG. 26).

The data access processing unit 123 performs the write processing to the reserved buffer area (S121 of FIG. 26).

The data access processing unit 123 performs the REC processing to the other storage device 1 with the buffer area as the relocation source (S122 of FIG. 26).

The data access processing unit 123 releases the buffer area by deleting the data written into the buffer area (S123 of FIG. 26).

The data access processing unit 123 returns a write I/O completion response to the host device 2 (S124 of FIG. 26), and the process ends.

If the REC processing is being performed (S119 of FIG. 26: Yes), the data access processing unit 123 writes data into a storage unit 21 of the relocation source for REC processing which is provided in the own storage device 1 (S125 of FIG. 26).

The data access processing unit 123 migrates the written data to the other storage device 1 by the synchronous REC function (S126 of FIG. 26).

The data access processing unit 123 returns a write I/O completion response to the host device 2 (S127 of FIG. 26), and the process ends.

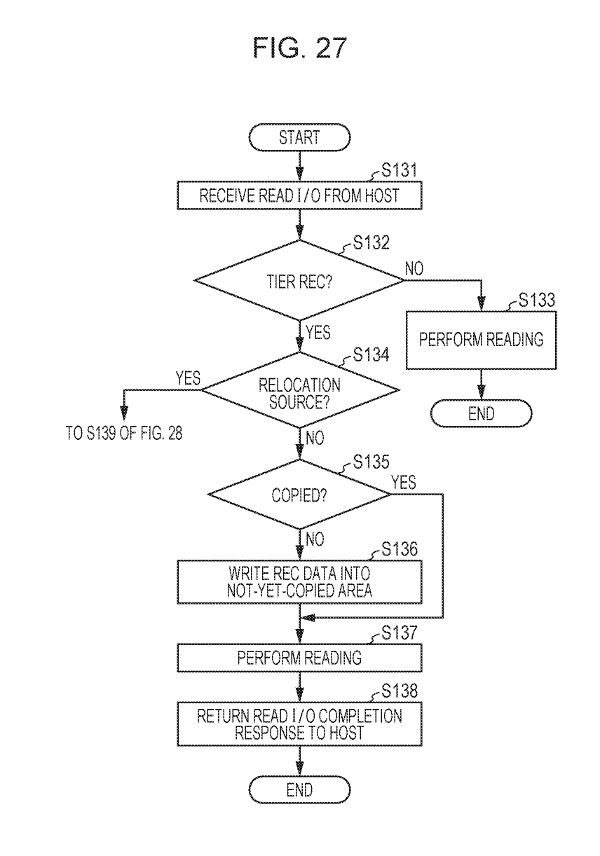

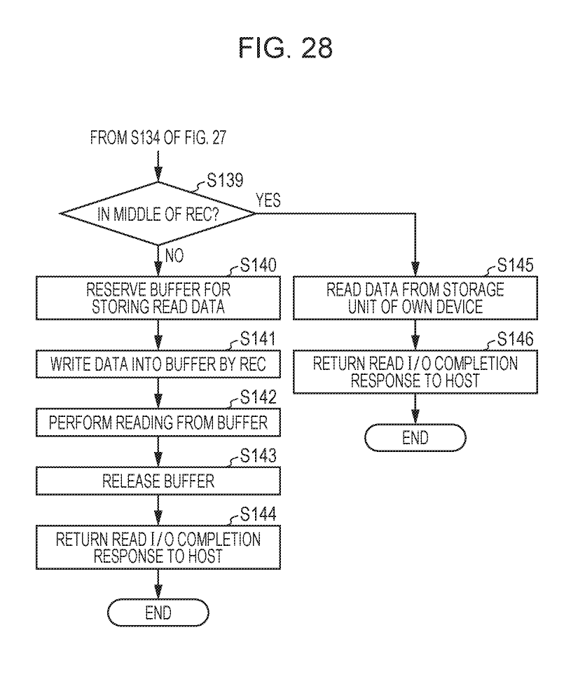

Next, read processing in the storage system 100 according to the embodiment is described with reference to flowcharts illustrated in FIGS. 27 and 28.

The data access processing unit 123 receives a read I/O from the host device 2 (S131 of FIG. 27).

The data located device determination unit 122 determines whether there is a tier REC in the read target area of the virtual volume 14 to which read data access is made (S132 of FIG. 27). That is, the data located device determination unit 122 determines whether the session information 137 is stored in the memory 13 of its own storage device 1 and data relocation processing has been performed between storage devices 1 in the past. For example, the data located device determination unit 122 refers to the virtual volume 14 and access range thereof in which the read processing is performed and the virtual volume number of the session table, the virtual volume start LBA, and the chunk size to determine whether there is a tier REC.

If there is no tier REC (S132 of FIG. 27: No), the data access processing unit 123 performs the read processing to a storage unit 21 provided in its own storage device 1 (S133 of FIG. 27), and the process ends.

If there is a tier REC (S132 of FIG. 27: Yes), the data located device determination unit 122 determines whether its own storage device 1 includes the storage unit 21 of the relocation source in the REC processing (S134 of FIG. 27). The data located device determination unit 122 determines whether the own storage device 1 is the relocation source, for example, with reference to the item “ROLE” of the session table (see FIG. 6).

If the own storage device 1 does not include the storage unit 21 of the relocation source (S134 of FIG. 27: No), the data access processing unit 123 determines whether the read target area has been copied from another storage device 1 (S135 of FIG. 27). The data access processing unit 123 determines whether the read target area has been copied, for example, with reference to the item “PHASE” of the session table (see FIG. 6).

If the read target area has been copied (S135 of FIG. 27: Yes), the process shifts to S137.

If the read target area has not been copied (S135 of FIG. 27: No), the write processing unit 120 obtains data from the other storage device 1 by REC. Then, the write processing unit 120 writes the obtained data into the area not yet copied (S136 of FIG. 27).

The data access processing unit 123 performs the read processing to the read target area (S137 of FIG. 27).

The data access processing unit 123 returns a read I/O completion response to the host device 2 (S138 of FIG. 27), and the process ends.

If the own storage device 1 includes the storage unit 21 of the relocation source (S134 of FIG. 27: Yes), the data access processing unit 123 determines whether the REC processing is being performed (S139 of FIG. 28). The data access processing unit 123 determines whether the REC processing is being performed, for example, with reference to the item “STATE” or “PHASE” of the session table (see FIG. 6).

If the REC processing is not being performed (S139 of FIG. 28: No), the data access processing unit 123 reserves a buffer area for storing the read target data, for example, in the memory 13 of the own storage device 1 (S140 of FIG. 28).

The data access processing unit 123 obtains data by the REC from the other storage device 1. Then, the data access processing unit 123 writes the obtained data into the reserved area (S141 of FIG. 28).

The data access processing unit 123 performs the read processing of the data written into the buffer area (S142 of FIG. 28).

The data access processing unit 123 releases the buffer area by deleting the data written into the buffer area (S143 of FIG. 28).

The data access processing unit 123 returns a read I/O completion response to the host device 2 (S144 of FIG. 28), and the process ends.

If the REC processing is being performed (S139 of FIG. 28: Yes), the data access processing unit 123 reads data from the storage unit 21 of the relocation source for the REC processing provided in the own storage device 1 (S145 of FIG. 28).

The data access processing unit 123 returns a read I/O completion response to the host device 2 (S146 of FIG. 28), and the process ends.

The CM 10 (controller) in the example of the above embodiment is, for example, capable of providing the following working effects.

When the relocation device determination unit 114 determines that the storage unit 21 of the relocation source is provided in its own storage device #0 and the storage unit 21 of the relocation destination is provided in another storage device #1, the data migration processing unit 119 copies data into the storage device #1 by using the inter-device copy function. Thus, the data migration processing unit 119 migrates the data into the storage device #1.

When the relocation device determination unit 114 determines that the storage unit 21 of the relocation source is provided in the storage device #1 and the storage unit 21 of the relocation destination is provided in the storage device #0, the write processing unit 120 obtains data from the storage device #1 by using the inter-device copy function. Then, the write processing unit 120 writes the obtained data into the storage unit 21 of the relocation destination.

Thus, the storage units 21 provided in the storage system 100 may be utilized effectively. Specifically, resources may be utilized effectively in the entire storage system 100 by relocating data stored in the storage unit 21 of its own storage device #0 into an area where the storage unit 21 of another storage device #1 is not utilized. Then, the relocation target data may be relocated into a storage unit 21 having an appropriate data access performance on the basis of the data access frequency. Also, limitation to the number of storage units 21 which may be used in one storage device 1 might not be imposed. Further, the host device 2 may issue the data relocation instruction without recognizing the storage devices 1 including storage units 21 of the relocation source and the relocation destination of the data.

When the data is migrated by the data migration processing unit 119, the copy session information generation unit 117 generates the session information 137 about the migration of the data. Then, on the basis of the session information 137 generated by the copy session information generation unit 117, the relocation device determination unit 114 determines the storage devices 1 including the storage units 21 of the relocation source and the relocation destination.

When the write processing unit 120 writes the data, the copy session information updating unit 118 updates the session information 137 generated by the copy session information generation unit 117. Then, on the basis of the session information 137 updated by the copy session information updating unit 118, the relocation device determination unit 114 determines the storage devices 1 including the storage units 21 of the relocation source and the relocation destination.

Thus, the relocation device determination unit 114 may easily determine the storage devices 1 including the storage units 21 of the relocation source and the relocation destination. Also, the storage device 1 may manage relocation target data in an appropriate manner and thereby improve reliability of the storage system 100.

The storage group information generation unit 113 generates the tier management group information 136 on the basis of the generated tier group information 135 for its own storage device #0 and the obtained tier group information 135 for another storage device #1. Then, on the basis of the tier management group information 136 generated by the storage group information generation unit 113, the relocation device determination unit 114 determines the storage devices 1 including the storage units 21 of the relocation source and the relocation destination.

Thus, the relocation device determination unit 114 may easily determine the storage devices 1 including storage units 21 of the relocation source and the relocation destination. The operator may set multiple tier groups 101 belonging to the tier management group 102.

When the relocation device determination unit 114 determines that the storage unit 21 of the relocation source is provided in another storage device #1 and the storage unit 21 of the relocation destination is provided in yet another storage device #2, the relocation instruction unit 121 issues to the storage device #1 a relocation instruction of data into the storage device #2.

This enables effective utilization of the storage units 21 provided in the storage system 100 even when the storage system 100 including three or more storage devices 1 performs relocation processing between other storage devices 1. Further, time for data relocation processing may be reduced since the other storage device #1 performs the data relocation processing directly with the yet-other storage device #2.

When the data located device determination unit 122 has determined that data to be accessed is not located in the storage unit 21 provided in its own storage device #0, the data access processing unit 123 performs data access to a storage unit 21 provided in another storage device 1 via the buffer memory.

With this, even when data is relocated to another storage device #1 by the data relocation processing, read processing and write processing of the relocated data may be performed easily.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A controller included in a first storage device communicably connected to a second storage device, the controller comprising:
a processor configured to
determine a source storage device and a destination storage device upon receiving a relocation instruction, the relocation instruction instructing to relocate first data from a source storage unit to a destination storage unit, the source storage device including the source storage unit, the destination storage device including the destination storage unit, the source storage unit being a relocation source of the first data, the destination storage unit being a relocation destination of the first data, and
migrate, upon determining that the source storage device is the first storage device and that the destination storage device is the second storage device, the first data by copying the first data to the second storage device by using an inter-device copy function.

2. The controller according to claim 1, wherein
the processor is configured to
request, before migrating the first data, the second storage device to reserve, in the destination storage unit, a memory area for storing the first data.

3. The controller according to claim 1, wherein
the processor is configured to
obtain, upon determining that the source storage device is the second storage device and that the destination storage device is the first storage device, the first data copied to the first storage device by the second storage device by using the inter-device copy function, and
write the first data into the destination storage unit.

4. The controller according to claim 3, wherein
the processor is configured to
reserve in the destination storage unit, before writing the first data, a memory area for storing the first data.

5. The controller according to claim 1, wherein
the processor is configured to
generate, when migrating the first data, copy session information about the migration, and
perform the determination thereafter on basis of the generated copy session information.

6. The controller according to claim 3, wherein
the processor is configured to
update, when writing the first data, copy session information about the migration, and
perform the determination thereafter on basis of the updated copy session information.

7. The controller according to claim 1, wherein
the processor is configured to
generate first storage information, the first storage information being used for managing information on first storage units included in the first storage device depending on a data access performance of each of the first storage units,
obtain second storage information from the second storage device, the second storage information being used for managing information on second storage units included in the second storage device depending on a data access performance of each of the second storage units,
generate storage group information on basis of the first storage information and the second storage information, and
perform the determination on basis of the storage group information.

8. The controller according to claim 1, wherein
the first storage device and the second storage device are communicably connected to a third storage device, and
the processor is configured to
instruct, upon determining that the source storage device is the second storage device and that the destination storage device is the third storage device, the second storage device to relocate the first data from the second storage device to the third storage device.

9. The controller according to claim 1, further comprising:
a buffer memory,
wherein
the processor is configured to
determine, upon receiving an access request to second data, a data-located storage device including a data-located storage unit storing the second data, and
perform, upon determining that the data-located storage device is the second storage device, data access to the data-located storage unit via the buffer memory.

10. A storage system, comprising:
a first storage device; and
a second storage device,
wherein
the first storage device includes:
a first processor configured to
determine a source storage device and a destination storage device upon receiving a relocation instruction, the relocation instruction instructing to relocate first data from a source storage unit to a destination storage unit, the source storage device including the source storage unit, the destination storage device including the destination storage unit, the source storage unit being a relocation source of the first data, the destination storage unit being a relocation destination of the first data, and
migrate, upon determining that the source storage device is the first storage device and that the destination storage device is the second storage device, the first data by copying the first data to the second storage device by using an inter-device copy function, and
the second storage device includes:
a second processor configured to
obtain the first data copied to the second storage device by the first processor, and
write the first data into the destination storage unit.

11. The storage system according to claim 10, wherein
the first processor is configured to
request, before migrating the first data, the second storage device to reserve, in the destination storage unit, a memory area for storing the first data, and
the second processor is configured to
reserve the memory area in the destination storage unit in response to the request from the first processor.

12. The storage system according to claim 10, wherein
the second processor is configured to
migrate, upon the first processor determining that the source storage device is the second storage device and that the destination storage device is the first storage device, the first data by copying the first data to the first storage device by using the inter-device copy function, and
the first processor is configured to
obtain the first data copied to the first storage device by the second processor, and
write the first data into the destination storage unit.

13. The storage system according to claim 12, wherein
the first processor is configured to
reserve in the destination storage unit, before writing the first data, a memory area for storing the first data.

14. The storage system according to claim 10, further comprising:
a third storage device,
wherein
the first processor is configured to
instruct, upon determining that the source storage device is the second storage device and that the destination storage device is the third storage device, the second storage device to relocate the first data from the second storage device to the third storage device,
the second processor is configured to
copy, upon receiving from the first processor the instruction to relocate the first data, the first data to the third storage device by using the inter-device copy function, and
the third storage device includes:
a third processor configured to
obtain the first data copied to the third storage device by the second processor, and
write the first data into the destination storage unit.

15. A computer-readable recording medium having stored therein a program that causes a computer to execute a process, the computer being included in a first storage device communicably connected to a second storage device, the process comprising:
determining a source storage device and a destination storage device upon receiving a relocation instruction, the relocation instruction instructing to relocate first data from a source storage unit to a destination storage unit, the source storage device including the source storage unit, the destination storage device including the destination storage unit, the source storage unit being a relocation source of the first data, the destination storage unit being a relocation destination of the first data; and
migrating, upon determining that the source storage device is the first storage device and that the destination storage device is the second storage device, the first data by copying the first data to the second storage device by using an inter-device copy function.

16. The computer-readable recording medium according to claim 15, the process further comprising:
obtaining, upon determining that the source storage device is the second storage device and that the destination storage device is the first storage device, the first data copied to the first storage device by the second storage device by using the inter-device copy function; and
writing the first data into the destination storage unit.

17. The computer-readable recording medium according to claim 15, the process further comprising:
generating, when migrating the first data, copy session information about the migration; and
performing the determination thereafter on basis of the generated copy session information.

18. The computer-readable recording medium according to claim 16, the process further comprising:
updating, when writing the first data, copy session information about the migration; and
performing the determination thereafter on basis of the updated copy session information.

19. The computer-readable recording medium according to claim 15, the process further comprising:
generating first storage information, the first storage information being used for managing information on first storage units included in the first storage device depending on a data access performance of each of the first storage units;
obtaining second storage information from the second storage device, the second storage information being used for managing information on second storage units included in the second storage device depending on a data access performance of each of the second storage units;
generating storage group information on basis of the first storage information and the second storage information; and
performing the determination on basis of the storage group information.

20. The computer-readable recording medium according to claim 15, wherein
the first storage device and the second storage device are communicably connected to a third storage device,
the process further comprising:
instructing, upon determining that the source storage device is the second storage device and that the destination storage device is the third storage device, the second storage device to relocate the first data from the second storage device to the third storage device.
